(19) United States
(12) Patent Application Publication
(10) Pub. No.: US 2025/0292339 A1
(43) Pub. Date: Sep. 18, 2025

(54) MATCHING SYSTEM, CUSTOMER TERMINAL DEVICE, AND PROGRAM

(71) Applicant: ASAHI KASEI HOMES CORPORATION, Tokyo (JP)

(72) Inventors: Kaori ITO, Tokyo (JP); Shinichiro KAWAI, Tokyo (JP)

(73) Assignee: ASAHI KASEI HOMES CORPORATION, Tokyo (JP)

(21) Appl. No.: 18/862,720

(22) PCT Filed: Dec. 20, 2022
(86) PCT No.: PCT/JP2022/046906

§ 371 Date: Nov. 4, 2024

(30) Foreign Application Priority Data
May 9, 2022 (JP) 2022-077119

(51) Int. Cl. G06Q 50/10; G06Q 10/0833; G06Q 50/00

(52) U.S. Cl. CPC G06Q 50/10; G06Q 10/0833; G06Q 50/01

(57) ABSTRACT

A matching system includes: a situation evaluation result acquisition unit configured to acquire a situation evaluation result according to customer needs; a customer-side priority determination unit configured to determine priority of a customer for the needs based on the situation evaluation result and a predetermined index criterion; a customer-side service selection unit configured to select a candidate for a service based on the situation evaluation result and the determined priority of the customer; a provision condition acquisition unit configured to acquire a provision condition of the service; a customer-side information acquisition unit configured to acquire the candidate for the service to be matched; a provider-side information acquisition unit configured to acquire the provision condition; an extraction unit configured to extract services of a proposal candidate; a matching unit configured to select a service to be proposed to the customer; and a presentation unit configured to present the service selected.

### TECHNICAL FIELD

The present invention relates to a matching system, a customer terminal device, and a program.

### BACKGROUND ART

As a technology for making proposals for maintaining or improving the quality of life (hereinafter, referred to as “QOL”) of a consumer, for example, Patent Document 1 discloses a technology for introducing a service for improving the QOL to an elderly person.

### CITATION LIST

### Patent Document

Patent Document 1: Japanese Unexamined Patent Application, First Publication No. 2014-134915

### SUMMARY OF INVENTION

### Technical Problem

The QOL of the consumer is affected by various elements such as information about health of the consumer and information about residence or living. However, it is generally difficult for the consumers for themselves to determine what kind of service is received to improve the QOL. In related art, there is a problem in that only a specific type of service can be received, and it is not possible to provide an appropriate type of service in order to improve the QOL of the individual consumers.

In view of the above circumstances, an object of the present invention is to provide a technology capable of proposing an appropriate type of service for both a customer and a service provider.

### Solution to Problem

According to one aspect of the present invention, there is provided a matching system including: a situation evaluation result acquisition unit configured to acquire a situation evaluation result including a service proposal content for a customer according to customer needs; a customer-side priority determination unit configured to determine priority of the customer for the needs based on the situation evaluation result and a predetermined index criterion; a customer-side service selection unit configured to select a candidate for a service to be matched from among a plurality of services based on the situation evaluation result and the determined priority of the customer; a provision condition acquisition unit configured to acquire a provision condition of the service of a service provider; a customer-side information acquisition unit configured to acquire the selected candidate for the service to be matched; a provider-side information acquisition unit configured to acquire the provision condition; an extraction unit configured to extract services of a proposal candidate based on the acquired candidate for the service to be matched and the provision condition on a provider side; a matching unit configured to select a service to be proposed to the customer from among the extracted services of the proposal candidate; and a presentation unit configured to present the service selected by the matching unit to the customer and the service provider.

According to one aspect of the present invention, in the above-described matching system, the customer-side priority determination unit determines whether or not the customer needs indicated by the situation evaluation result correspond to a life event that is an important event in a lifetime of the customer, based on a predetermined determination criterion.

According to one aspect of the present invention, the above-described matching system further includes: a delivery date information acquisition unit configured to acquire delivery date information of the service provided by the service provider, in which the provider-side information acquisition unit further acquires the delivery date information, and the presentation unit presents the delivery date information of the extracted services of the proposal candidate to the customer.

According to one aspect of the present invention, the above-described matching system further includes: a delivery date information acquisition unit configured to acquire delivery date information of the service provided by the service provider, in which the provider-side information acquisition unit further acquires the delivery date information, and the matching unit selects a service to be proposed to the customer by giving priority to a service with an earlier delivery date, based on the extracted services of the proposal candidate and the delivery date information of the services.

According to one aspect of the present invention, in the above-described matching system, the customer-side service selection unit selects a service with a relatively low added value when the priority of the customer is relatively low, and selects a service with a relatively high added value when the priority of the customer is relatively high, from among the plurality of services.

According to one aspect of the present invention, in the above-described matching system, the service with the relatively low added value includes a standard service provided by predetermined condition determination, and the service with the relatively high added value includes a non-standard service provided by individual consideration based on a situation of the customer.

According to one aspect of the present invention, there is provided a customer terminal device including: a situation evaluation result acquisition unit configured to acquire a situation evaluation result including a service proposal content for a customer according to customer needs; a customer-side priority determination unit configured to determine priority of the customer for the needs based on the situation evaluation result and a predetermined index criterion; a customer-side service selection unit configured to select a candidate for a service to be matched from among a plurality of services based on the situation evaluation result and the determined priority of the customer; an acquisition unit configured to acquire, from a matching server, information of the service selected based on the candidate for the service to be matched, which is selected by the customer-side service selection unit, and a provision condition of the service on a provider side; a presentation unit configured to present the acquired information of the service.

According to one aspect of the present invention, there is provided a program for causing a computer to: acquire a situation evaluation result including a service proposal content for a customer according to customer needs; determine priority of the customer for the needs based on the situation evaluation result and a predetermined index criterion; select a candidate for a service to be matched from among a plurality of services based on the situation evaluation result and the determined priority of the customer; acquire a provision condition of the service of a service provider; acquire the selected candidate for the service to be matched; acquire the provision condition; extract services of a proposal candidate based on the acquired candidate for the service to be matched and the provision condition on a provider side; select a service to be proposed to the customer from among the extracted services of the proposal candidate; and present the selected service to the customer and the service provider.

### Advantageous Effects of Invention

It is possible to propose an appropriate type of service for both the customer and the service provider.

### BRIEF DESCRIPTION OF DRAWINGS

FIG. 1 A diagram showing an example of a functional configuration of a matching system according to the present embodiment.

FIG. 2 A diagram showing an example of a device configuration of a customer terminal device according to the present embodiment.

FIG. 3 A diagram showing an example of a flow of an operation of the matching system according to the present embodiment.

FIG. 4 A diagram showing an example of items of customer situation evaluation according to the present embodiment.

FIG. 5 A diagram showing another example of items of customer situation evaluation according to the present embodiment.

FIG. 6 A diagram showing a first example of a relationship between customer needs and a service proposal content according to the present embodiment.

FIG. 7 A diagram showing a second example of a relationship between customer needs and a service proposal content according to the present embodiment.

FIG. 8 A diagram showing a third example of a relationship between customer needs and a service proposal content according to the present embodiment.

FIG. 9 A diagram showing an example of a life event according to the present embodiment.

FIG. 10 A diagram showing an example of a flow of selecting a service candidate according to the present embodiment.

FIG. 11 A diagram showing an example of customer-side information transmitted to a matching server according to the present embodiment.

FIG. 12 A diagram showing an example of service provider-side information transmitted to the matching server according to the present embodiment.

FIG. 13 A diagram showing an example of matching of services according to the present embodiment.

FIG. 14 An example of contents of a matching result presented to the customer terminal device according to the present embodiment.

FIG. 15 An example of contents of the matching result presented to a service provider terminal device according to the present embodiment.

FIG. 16 A diagram schematically showing a device configuration and a use environment of an information management system according to the embodiment.

FIG. 17 A functional block diagram showing a functional configuration of a terminal.

FIG. 18 A diagram schematically showing a flow of information such as proposal information.

FIG. 19 A diagram showing a database.

FIG. 20 A diagram showing biometric information and living information.

FIG. 21 A diagram showing an example of data items of the biometric information belonging to an independence degree/nursing care degree.

FIG. 22 A diagram showing an example of data items of the biometric information belonging to an exercise function.

FIG. 23 A diagram showing an example of data items of the living information belonging to a residence space.

FIG. 24 A diagram showing an example of data items of the living information belonging to a lifestyle.

FIG. 25A A diagram showing an example of data contents of an analysis database.

FIG. 25B A diagram showing an example of data contents of an analysis database.

FIG. 26 A diagram showing an example of an input screen.

FIG. 27 A diagram showing an example of biometric/living information.

FIG. 28 A diagram showing an example of the proposal information.

FIG. 29 A flowchart showing a flow of processing of the information management system.

FIG. 30 A diagram schematically showing a device configuration and a use environment of an information management system according to the embodiment.

FIG. 31 A functional block diagram showing a functional configuration of a terminal.

FIG. 32 A diagram schematically showing a flow of information and an output of a timing generation unit.

FIG. 33 A diagram showing a database.

FIG. 34 A diagram showing an example of biometric information recorded in a biometric information database.

FIG. 35 A diagram showing an example of living information recorded in a living information database.

FIG. 36 A diagram showing an example of building information recorded in a building information database.

FIG. 37 A diagram showing an example of money information recorded in a money information database.

FIG. 38 A diagram showing an example of an event.

FIG. 39 A diagram showing an event database.

FIG. 40 A diagram showing a definition of timing.

FIG. 41 A diagram showing a timing database.

FIG. 42 A schematic diagram showing contents of the timing database together with the event.

FIG. 43 A flowchart showing a flow of processing of the information management system.

FIG. 44 A diagram showing an example of analysis information recorded in an analysis database.

FIG. 45 A diagram showing an example of analysis information recorded in the analysis database.

FIG. 46 A diagram showing an example of a stress degree and an event recorded in a stress database.

FIG. 47 A diagram showing an example of an input screen.

### DESCRIPTION OF EMBODIMENTS

### [Functional Configuration of Matching System 1]

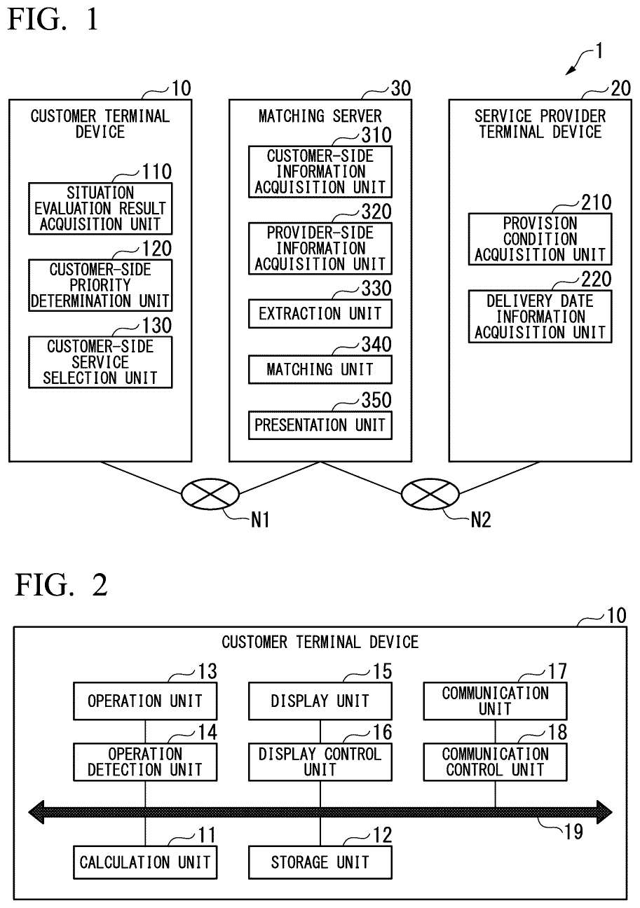

FIG. 1 is a diagram showing an example of a functional configuration of a matching system 1 according to the present embodiment. In the matching system 1, a customer terminal device 10, a service provider terminal device 20, and a matching server 30 are connected to each other via a network (network N1 and network N2) in a communicatable manner. A customer according to the present embodiment is assumed to be an individual of a so-called senior generation or middle generation.

The customer terminal device 10 is a terminal device used by the customer of the matching system 1. An example of a device configuration of the customer terminal device 10 will be described with reference to FIG. 2.

In the following description, although the customer terminal device 10 is described, the customer terminal device 10 does not necessarily have to be operated by the customer himself/herself. For example, the customer terminal device 10 may be a terminal operated by a business operator or the like who provides a matching service to the customer (that is, a business operator or the like that acts on behalf of the customer). That is, in the following description, the use of the matching service by the customer includes a case where the customer uses the matching service by directly operating the same and a case where the customer uses the matching service by indirectly operating the same via a business operator or the like.

### [Device Configuration of Customer Terminal Device 10]

FIG. 2 is a diagram showing an example of a device configuration of the customer terminal device 10 according to the present embodiment. The customer terminal device 10 is, for example, a computer device such as a smartphone, a tablet, or a personal computer. The customer terminal device 10 includes a calculation unit 11, a storage unit 12, an operation unit 13, an operation detection unit 14, a display unit 15, a display control unit 16, a communication unit 17, a communication control unit 18, and a bus 19.

The calculation unit 11 has a calculation function such as a central processing unit (CPU), and realizes various functions based on a program stored in the storage unit 12.

The operation unit 13 includes an input device such as a touch panel, a keyboard, or a mouse, and receives an operation on the customer terminal device 10.

The operation detection unit 14 detects an operation on the operation unit 13 and transmits the operation to the calculation unit 11.

The display unit 15 includes an output device such as a liquid crystal display, and displays various types of information.

The display control unit 16 displays information on the display unit 15 based on the control of the calculation unit 11.

The communication unit 17 performs wireless or wired communication with another device (for example, the matching server 30).

The communication control unit 18 performs communication with the communication unit 17 based on the control of the calculation unit 11.

The bus 19 connects the above-described units to each other and enables the exchange of the information between the units.

The service provider terminal device 20 and the matching server 30 are also the same computer devices as the customer terminal device 10 and include the same configurations as the customer terminal device 10. The device configurations of the service provider terminal device 20 and the matching server 30 will not be described.

Referring back to FIG. 1, the customer terminal device 10 includes a situation evaluation result acquisition unit 110, a customer-side priority determination unit 120, and a customer-side service selection unit 130 as functional units.

The service provider terminal device 20 includes a provision condition acquisition unit 210 and a delivery date information acquisition unit 220 as functional units.

The matching server 30 includes a customer-side information acquisition unit 310, a provider-side information acquisition unit 320, an extraction unit 330, a matching unit 340, and a presentation unit 350 as functional units.

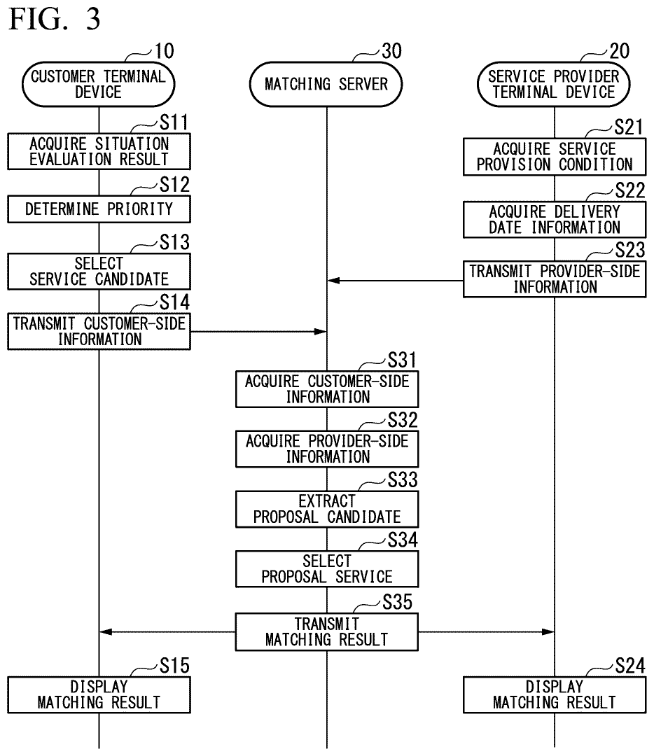

Specific operations of these devices will be described with reference to FIG. 3.

### [Operation of Matching System 1]

FIG. 3 is a diagram showing an example of a flow of an operation of the matching system 1 according to the present embodiment. First, a flow of an operation of the customer terminal device 10 will be described.

### [Operation of Customer Terminal Device 10]

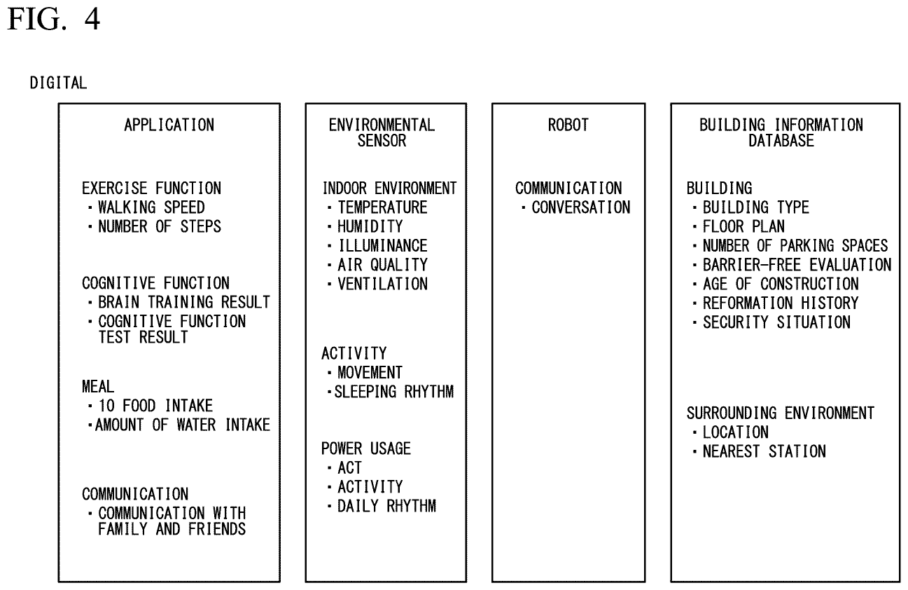

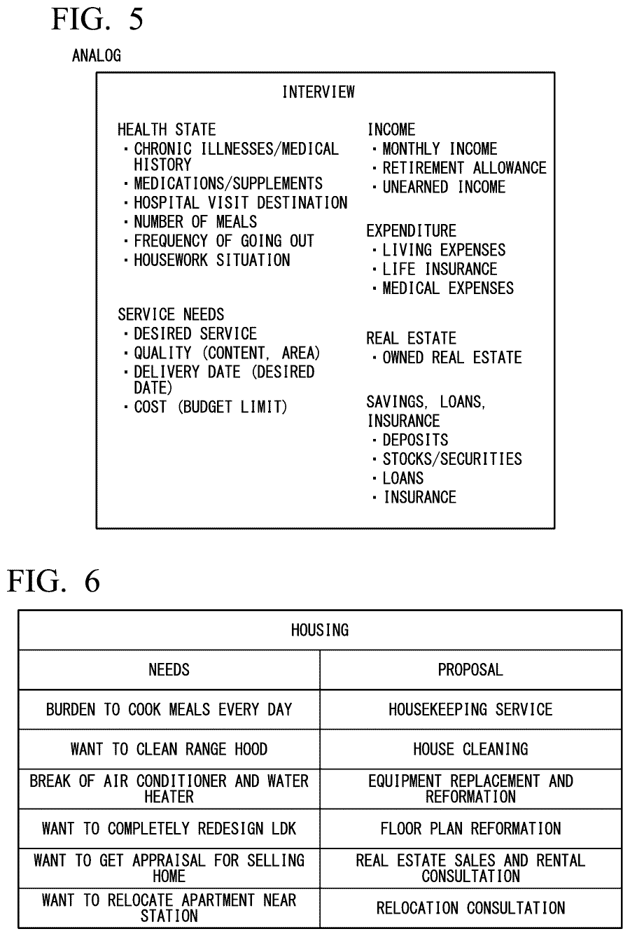

(Step S11) The situation evaluation result acquisition unit 110 of the customer terminal device 10 acquires a situation evaluation result of the customer. An example of a situation evaluation item of the customer will be described with reference to FIGS. 4 and 5.

### [Customer Situation Evaluation]

FIG. 4 is a diagram showing an example of items of customer situation evaluation according to the present embodiment. FIG. 4 shows an example of situations of the customer, which are automatically collected by a digital device. The digital device includes, for example, the customer terminal device 10, a sensor device or a robot device installed in the home of the customer, a wearable terminal worn by the customer, and the like.

FIG. 5 is a diagram showing another example of items of customer situation evaluation according to the present embodiment. FIG. 5 shows an example of situations of the customer, which are collected by an analog method. The analog method includes, for example, a visit assessment by a provider of the matching system 1, a remote assessment using a web conference system, listening by telephone, filling out a questionnaire, and the like.

That is, the situations of the customer may be automatically collected from the customer (for example, in a state in which the customer is not aware of the situation) or may be collected as an answer to a question to the customer.

By organizing the collected situations of the customer, customer needs and a service proposal content for the needs are extracted.

The service proposal content may be extracted automatically (that is, online) by the matching system 1, or may be extracted manually (that is, offline) by a person in charge of service proposal of the business operator who provides the matching system 1. The customer needs and the service proposal content for the needs will be described with reference to FIGS. 6 to 8.

FIG. 6 is a diagram showing a first example of a relationship between customer needs and a service proposal content according to the present embodiment. FIG. 6 shows an example of a relationship between the customer needs and the service proposal content related to “housing”.

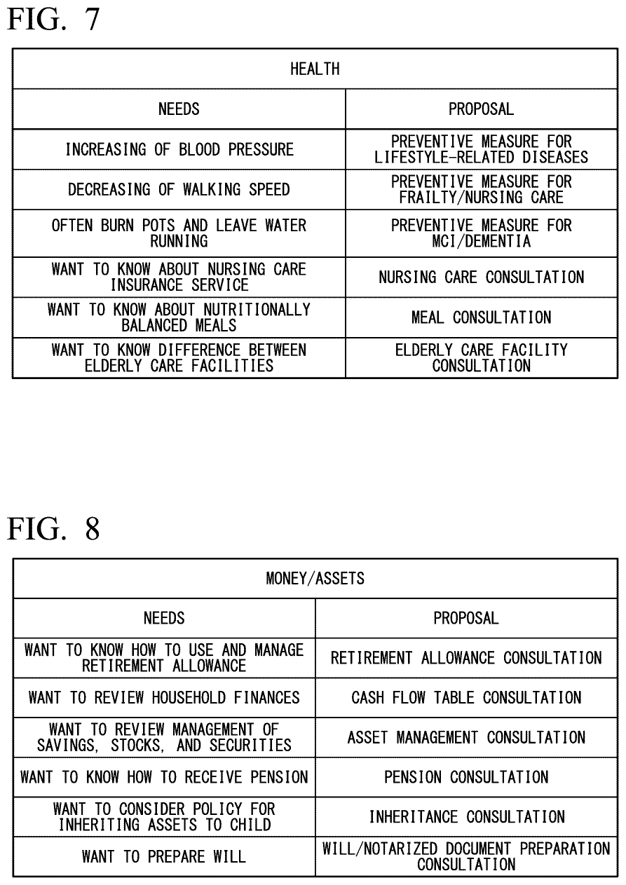

FIG. 7 is a diagram showing a second example of a relationship between customer needs and a service proposal content according to the present embodiment. FIG. 7 shows an example of a relationship between the customer needs and the service proposal content related to “health”.

FIG. 8 is a diagram showing a third example of a relationship between customer needs and a service proposal content according to the present embodiment. FIG. 8 shows an example of a relationship between customer needs and a service proposal content related to “money/assets”.

A work of extracting the customer needs and the service proposal content for the needs based on the collected situations of the customer may be performed offline (for example, manually by the person in charge of matching or by a computer device (for example, using a machine learning result). In addition, the matching system 1 may have a function of extracting the customer needs and the service proposal content for the needs.

The extracted customer needs and service proposal content are summarized as a situation evaluation result of the customer. That is, the situation evaluation result is information including a service proposal content for the customer according to the customer needs.

The situation evaluation result acquisition unit 110 acquires a situation evaluation result including the service proposal content for a customer according to the customer needs.

Referring back to FIG. 3, the situation evaluation result acquisition unit 110 outputs the acquired situation evaluation result of the customer to the customer-side priority determination unit 120.

(Step S12) The customer-side priority determination unit 120 determines priority of the customer needs (customer priority) from the customer viewpoint.

The customer priority is expressed by combining a level of urgency degree and a level of importance degree. For example, “the customer priority is high” refers to a case where any one of the level of urgency degree or the level of importance degree is high, and a case where both the level of urgency degree and the level of importance degree are high.

A predetermined index criterion is given for the priority of the customer needs from the customer viewpoint. The predetermined index criterion is stored in the storage unit 12 of the customer terminal device 10 or a storage unit (not shown) of the matching server 30.

The predetermined index criterion for the urgency degree indicates whether the customer needs correspond to: <red> level in which there is an immediate issue; <yellow> level in which it may be best to work on within a few months to half a year; and <blue> level in which there is enough time to consider the issue in advance. The predetermined index criterion for the importance degree indicates whether or not the customer needs are related to a predetermined life event.

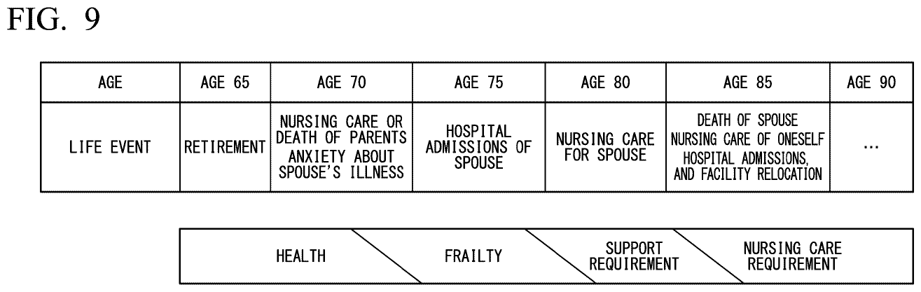

FIG. 9 is a diagram showing an example of a life event according to the present embodiment. The life event is an important event in the lifetime of the customer. For example, the life event includes “retirement” at the age of 65, “nursing care or death of parents” at the age of 70, and “anxiety about a spouse's illness”, and the like.

For example, when the customer needs are in the <red> level in which there is an immediate issue and are not related to the predetermined life event, it is determined that “urgency degree: high, and importance degree: low”.

When the customer needs are in the <blue> level in which there is enough time to consider the issue in advance and are related to the predetermined life event, it is determined that “urgency degree: low, and importance degree: high”.

The customer-side priority determination unit 120 determines a level of the customer needs by comparing the customer situation evaluation result with the level indicated by the predetermined index criterion.

That is, the customer-side priority determination unit 120 determines the priority of the customer for the needs based on the situation evaluation result and the predetermined index criterion.

In addition, the customer-side priority determination unit 120 determines whether or not the customer needs indicated by the situation evaluation result correspond to a life event that is an important event in the lifetime of the customer, based on a predetermined determination criterion.

The customer-side priority determination unit 120 outputs the determined priority to the customer-side service selection unit 130.

(Step S13) Referring back to FIG. 3, the customer-side service selection unit 130 selects a candidate for the service to be matched from among a plurality of services based on the situation evaluation result acquired in step S11 and the priority of the customer determined in step S12.

### [Determination of Customer Priority]

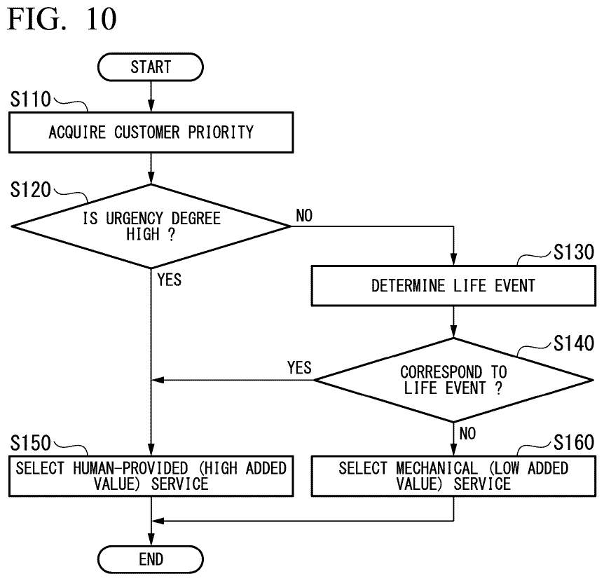

Here, an example of selecting a service candidate to be matched will be described with reference to FIG. 10.

FIG. 10 is a diagram showing an example of a flow of selecting a service candidate according to the present embodiment.

(Step S110) The customer-side service selection unit 130 acquires the customer priority determined in step S12.

(Step S120) When the customer-side service selection unit 130 determines that the level of urgency degree of the customer priority is high (for example, the level is <red>) (step S120: YES), the processing proceeds to step S150. When the customer-side service selection unit 130 determines that the level of urgency degree of the customer priority is not high (for example, the level is <yellow> or <blue>) (step S120: NO), the processing proceeds to step S130.

(Step S130) The customer-side service selection unit 130 determines whether or not the level of importance degree of the customer priority is high, that is, whether or not the customer needs are related to the predetermined life event.

When the customer-side service selection unit 130 determines that the customer needs are related to the predetermined life event (step S130: YES), the processing proceeds to step S150. When the customer-side service selection unit 130 determines that the customer needs are not related to the predetermined life event (step S130: NO), the processing proceeds to step S160.

(Step S150) The customer-side service selection unit 130 selects a high added value service (for example, a human-provided service) as the service candidate to be matched from among the services that can be provided. The human-provided service includes a housekeeping service, reformation, and the like. That is, the service with a relatively high added value includes a non-standard service provided by individual consideration based on the situation of the customer.

(Step S160) The customer-side service selection unit 130 selects a low added value service (for example, a service that is mechanically provided) as the service candidate to be matched from among the services that can be provided. The service that is mechanically provided includes a chat service for nursing care consultation using artificial intelligence (AI). That is, the service with a relatively low added value includes a standard service provided by predetermined condition determination.

That is, the customer-side service selection unit 130 selects the service with a relatively low added value when the priority of the customer is relatively low, and selects the service with a relatively high added value when the priority of the customer is relatively high, from among the plurality of services.

In step S150, the customer-side service selection unit 130 selects a service candidate to be matched (that is, the computer device selects the service candidate), but the present invention is not limited thereto. For example, when the customer priority is high, the selection work of the service candidate to be matched may be performed offline (for example, manually by the person in charge of matching). In this case, when it is determined that the customer priority is high, the customer-side service selection unit 130 may be configured to notify the person in charge of matching of the high customer priority and to prompt the person in charge of matching to perform the selection work offline. In addition, in this case, the customer-side service selection unit 130 may be configured to select the service to be matched by receiving a service selection operation by the person in charge of matching.

(Step S14) Referring back to FIG. 3, the customer-side service selection unit 130 transmits the selected service to the matching server 30 via the communication control unit 18 and the communication unit 17.

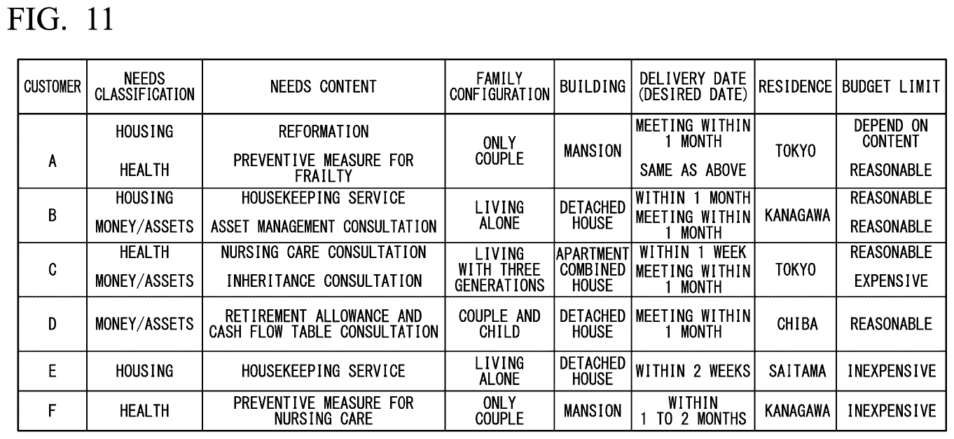

FIG. 11 is a diagram showing an example of customer-side information transmitted to the matching server 30 according to the present embodiment. In an example shown in FIG. 11, the customer-side information for customers A to F includes needs classification for each of the customers, a needs content, family composition, a type of building for residence, desired delivery date for service provision, a place of residence (relationship between the service provider and a provision area), a budget limit, and the like.

### [Operation of Service Provider Terminal Device 20]

(Step S21) The provision condition acquisition unit 210 of the service provider terminal device 20 acquires a provision condition of the service of the service provider.

(Step S22) The delivery date information acquisition unit 220 acquires delivery date information of the service provided by the service provider.

The service provider terminal device 20 generates service provider-side information based on the provision condition acquired by the provision condition acquisition unit 210 and the delivery date information acquired by the delivery date information acquisition unit 220.

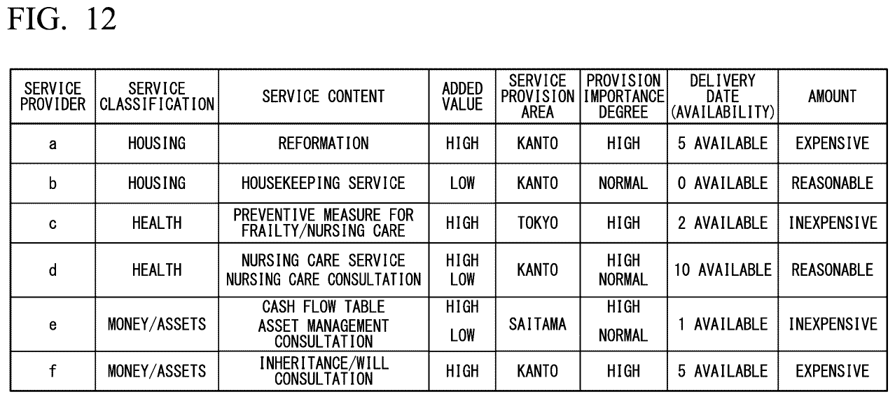

(Step S23) The service provider terminal device 20 transmits the generated service provider-side information to the matching server 30. FIG. 12 shows an example of the service provider-side information.

FIG. 12 is a diagram showing an example of the service provider-side information transmitted to the matching server 30 according to the present embodiment. In an example shown in FIG. 12, the service provider-side information for service providers a to f includes service classification for each of the providers, a service content, an added value, a service provision area, provision importance degree, a service provision delivery date, an amount, and the like.

### [Operation of Matching Server 30]

(Step S31) Referring back to FIG. 3, the customer-side information acquisition unit 310 of the matching server 30 acquires customer-side information transmitted from the customer terminal device 10 in step S14. The customer-side information indicates the selected candidates for the service to be matched. That is, the customer-side information acquisition unit 310 acquires the selected candidates for the service to be matched.

(Step S32) The provider-side information acquisition unit 320 acquires the service provider-side information transmitted from the service provider terminal device in step S23. The service provider-side information is information indicating a provision condition of the service provider. That is, the provider-side information acquisition unit 320 acquires the provision condition.

(Step S33) The extraction unit 330 extracts a service of proposal candidates based on the acquired candidates for the service to be matched and the provision condition on the provider side.

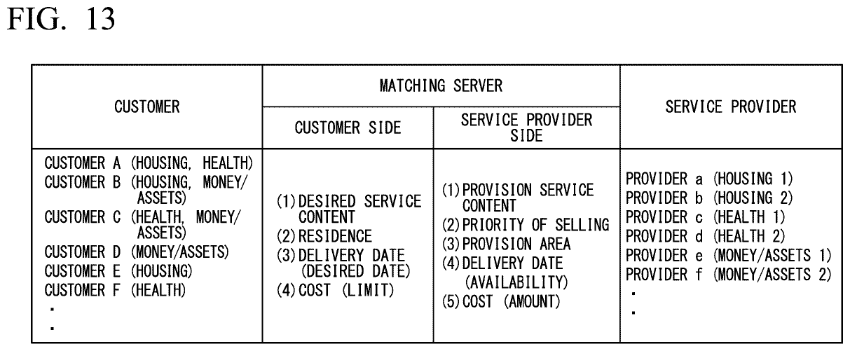

(Step S34) The matching unit 340 selects a service to be proposed to the customer from among the extracted services of the proposal candidates. FIG. 13 shows an example of matching by the matching unit 340.

FIG. 13 is a diagram showing an example of matching of services according to the present embodiment. The matching server 30 matches the customer needs with the service provision content of the service provider by comparing the customer-side information transmitted from the customer terminal device 10 with the service provider-side information transmitted from the service provider terminal device 20 for each customer and for each service provider.

Here, the service provider-side information transmitted from the service provider terminal device 20 includes delivery date information. That is, the provider-side information acquisition unit 320 acquires the delivery date information from the service provider terminal device 20. In this case, the matching unit 340 may select the service to be proposed to the customer by giving priority to the service with an earlier delivery date based on the extracted services of the proposal candidates and the delivery date information of the services.

(Step S35) The presentation unit 350 transmits a matching result to the customer terminal device 10 and the service provider terminal device 20. That is, the presentation unit 350 presents the service selected by the matching unit 340 to the customer and the service provider.

(Step S15) The customer terminal device 10 displays the matching result received from the matching server 30 on the display unit 15.

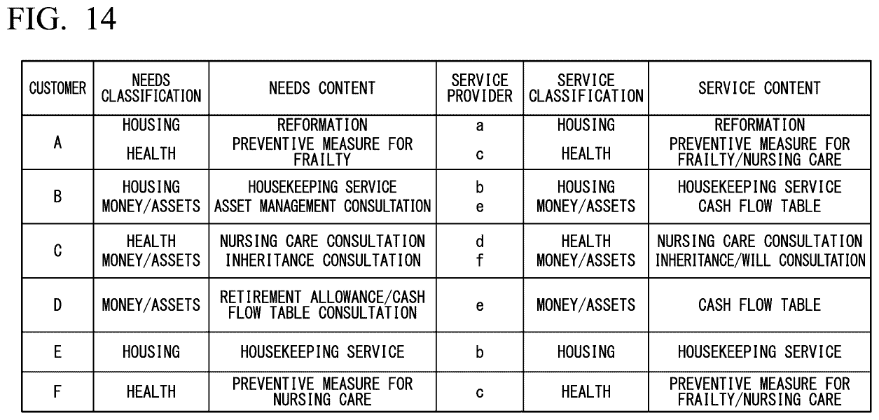

FIG. 14 shows an example of contents of the matching result presented to the customer terminal device 10 according to the present embodiment. In a case of the example shown in FIG. 14, for example, “housing: reformation” of the service provider a and “health: preventive measures for frailty and nursing care” of the service provider c are presented to the customer A.

(Step S24) The service provider terminal device 20 displays the matching result received from the matching server 30 on a display unit (not shown).

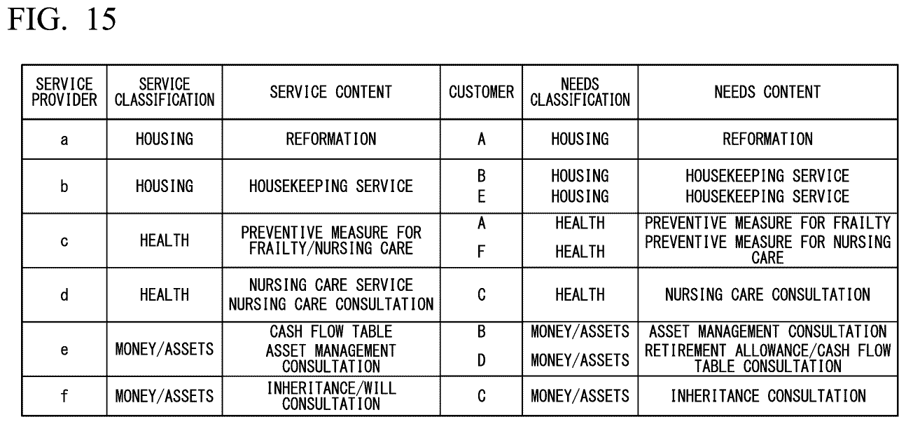

FIG. 15 shows an example of contents of the matching result presented to the service provider terminal device 20 according to the present embodiment. In a case of the example shown in FIG. 15, for example, the customer A is presented to the service provider a. In addition, the customer B and the customer E are presented to the service provider b.

The presentation unit 350 may present the delivery date information of the extracted services of proposal candidates to the customer.

As described above, according to the matching system 1, the customer and the service provider are matched based on their desires.

Here, the customer does not necessarily know himself/herself well.

Therefore, when the customer considers a service desired to be provided, a situation may occur in which only a specific field based on the subjective need is considered.

For example, in a case of the housekeeping service, the service content or the service provider is considered for cooking, cleaning, laundry, and the like. However, there may be cases where the real issues of the customer lie beyond the housekeeping service, such as health or money issues. It is difficult for the customer to objectively evaluate the situation and consider the service that is really necessary for the customer.

On the other hand, the service provider (business operator) may not well understand the approach method to the customer. Although it is possible to respond to inquiries and consultations from customers one by one, the response is passive, and it cannot be said that the management is performed efficiently. When the service provider can determine the priority of approaching the customer, the service provider approaches the customer at an appropriate timing from the viewpoint of the customer side, which is convenient. In addition, the service provider side can also efficiently utilize resources and secure sales and profits.

There are various services related to housing and living, and there are also various service providers (business operators) that provide these services. Since there are countless types of services and business operator who provides the services, it is difficult for the customer to consider the services, narrow down the options, and select an appropriate service or provider for themselves.

In addition, it is difficult for a service provider, amidst a large number of customers and prospects, to determine the priority of approaching customers who are more advantageous (leading to increased sales) for the service provider's business.

The matching system 1 according to the present embodiment presents a service content that matches the situations of both the customer and the service provider. Therefore, according to the matching system 1, it is possible to provide an appropriate service option and to receive and provide a service more efficiently and more quickly. In addition, according to the matching system 1 of the present embodiment, it is possible to make a proposal for a service derived from needs (latent needs) that the customer is not aware of, in addition to needs (manifest needs) that the customer is aware of.

In addition, according to the matching system 1 of the present embodiment, since the service is proposed based on the priority of the service that the service provider wants to provide, it is possible to indicate which customer should be provided with the service in what order.

### [About Information Management System]

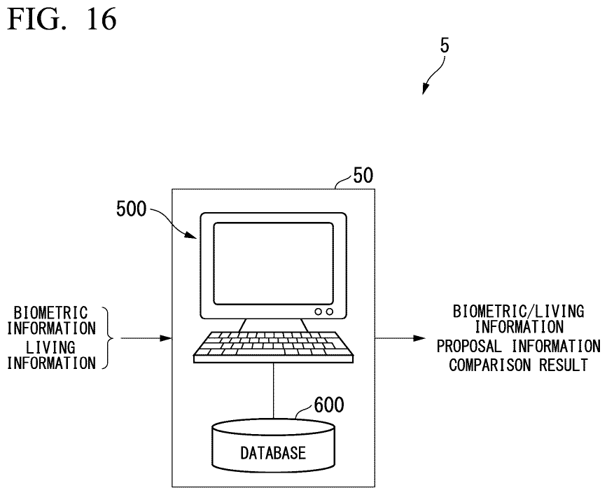

FIG. 16 is a diagram schematically showing a device configuration and a use environment of the information management system 5 according to the embodiment. The customer in the embodiment is assumed to be an individual of a so-called senior generation or middle generation. In the information management system 5, biometric information about the living body of the customer and living information about the living of the customer are input to a terminal 500 by an advisor who receives the consultation from the customer. The terminal 500 that has acquired the biometric information and the living information performs analysis using a database 600 based on a combination of the biometric information and living information, and derives proposal information for improving the quality of life (hereinafter, referred to as “QOL”) of the customer to output the proposal information. The advisor makes a proposal to the customer based on the output proposal information.

In addition, the information management system 5 outputs the biometric/living information in which the biometric information and the living information are summarized. Since the biometric information and the living information are different information in the related art, the biometric information and the living information are summarized to provide information about a proposal for maintaining and improving the QOL by using various information.

Further, the information management system 5 outputs a comparison result obtained by comparing history information described below with newly input information and the like.

The database 600 is stored in a cloud, a database server, or the like. The biometric information, the living information, and the details of the database 600 will be described below.

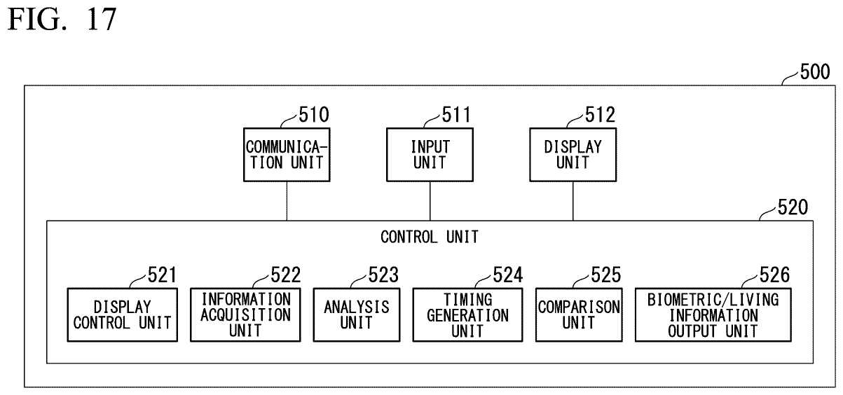

FIG. 17 is a functional block diagram showing a functional configuration of the terminal 500. The terminal 500 includes a central processing unit (CPU), a memory, an auxiliary storage device, and the like connected by a bus, and functions as a device including a communication unit 510, an input unit 511, a display unit 512, and a control unit 520 by executing an information management program.

The communication unit 510 performs communication for acquiring information from the database 600. The input unit 511 is configured by using an input device such as a touch panel, a mouse, and a keyboard. The input unit 511 may be an interface for connecting an input device to the terminal 500. In this case, the input unit 511 generates input data (for example, instruction information indicating an instruction to the terminal 500) from an input signal that is input by the input device, and inputs the input data to the terminal 500.

The display unit 512 is an output device such as a cathode ray tube (CRT) display, a liquid crystal display, or an organic electro luminescence (EL) display. The display unit 512 may be an interface for connecting the output device to the terminal 500. In this case, the display unit 512 generates a video signal from video data and outputs the video signal to a video output device connected to the display unit 512.

All or some of the functions of each of the communication unit 510 and the control unit 520 may be realized by using hardware such as an application specific integrated circuit (ASIC), a programmable logic device (PLD), or a field programmable gate array (FPGA).

The information management program may be recorded on a computer-readable recording medium. For example, the computer-readable recording medium is a portable medium such as a flexible disk, a magneto-optical disk, a ROM, and a CD-ROM, or a storage device such as a hard disk built in a computer system. The information management program may be transmitted via an electric communication line.

The control unit 520 in FIG. 17 controls an operation of each unit of the terminal 500. The control unit 520 is executed by a device including, for example, a processor such as a CPU and a RAM. The control unit 520 executes the information management program to function as a display control unit 521, an information acquisition unit 522, an analysis unit 523, a timing generation unit 524, and a comparison unit 525.

The display control unit 521 controls the entire screen displayed on the display unit 512. The information acquisition unit 522 acquires the biometric information and the living information by acquiring the information from the database 600 or acquiring the information input by the input unit 511. The analysis unit 523 performs analysis using the database 600 based on a combination of the acquired biometric information and living information, and derives the proposal information for improving the QOL of the customer. The derived proposal information is output to the display unit 512 by, for example, the display control unit 521, or is output as a printed matter by a printer (not shown).

The timing generation unit 524 generates a timing at which the analysis unit 523 derives the proposal information. Examples of the timing include a regular timing such as once a year, a timing at which new living information is input, and a timing at which an instruction from the advisor is input.

The comparison unit 525 compares the history information described later with newly input information and the like.

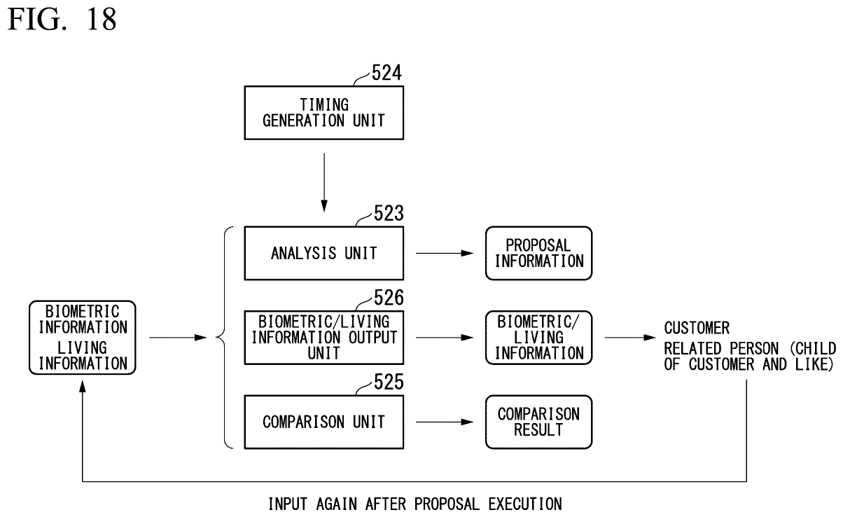

FIG. 18 is a diagram schematically showing a flow of information such as proposal information. First, the biometric information and the living information are input. The analysis unit 523 performs analysis using the database 600 based on a combination of the biometric information and living information at the timing generated by the timing generation unit 524, and derives the proposal information for improving the QOL of the customer to output the proposal information.

When there is proposal information that has been output in the past or the past biometric information and living information, the comparison unit 525 outputs a comparison result of comparing the comparable data items among the newly acquired biometric information and living information or the newly derived proposal information.

A biometric/living information output unit 526 summarizes the biometric information and the living information, and outputs biometric/living information in which the biometric information and the living information are associated with a customer number of the customer.

The output proposal information, biometric/living information, and comparison result are provided through the advisor to the customer himself/herself, family such as customer's children, or other related person such as a care manager in charge of the customer.

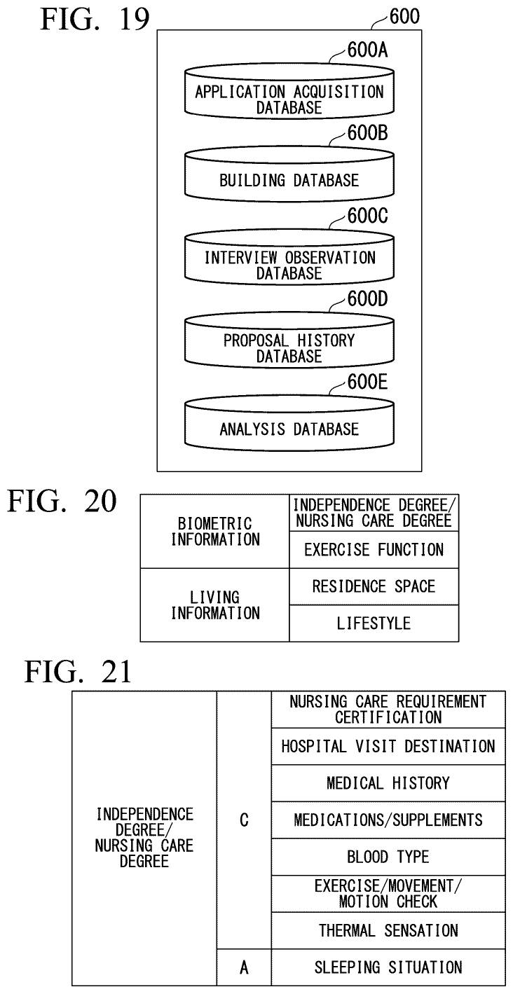

FIG. 19 is a diagram showing the database 600. The database 600 includes an application acquisition database 600A, a building database 600B, an interview observation database 600C, a proposal history database 600D, and an analysis database 600E. The database 600 is provided for each customer and is stored in association with a customer number (individual recognition information) that uniquely indicates the customer.

The application acquisition database 600A is a database that stores information automatically obtained by a device that acquires various information about a living body, such as a wearable device attached to a customer, or a device related to air conditioning or locking. Since the application acquisition database 600A is acquired by an application that acquires information from various devices, the application acquisition database 600A is collected by a server that integrally manages the application and is recorded as the application acquisition database 600A.

The building database 600B is a database that stores information about a building or the like in which the customer resides. The interview observation database 600C is a database that stores information obtained by the advisor interviewing the customer or observing the customer or the residence. The proposal history database 600D is a database that stores the proposal information that has been output in the past, the biometric information and living information at that time. The analysis database 600E is a database used when the analysis unit 523 performs analysis based on a combination of the biometric information and the living information.

FIG. 20 is a diagram showing the biometric information and the living information. As shown in FIG. 20, the biometric information is information about the independence degree and nursing care degree of the customer, and an exercise function of the customer. The living information is information indicating a residence space in which the customer resides (hard aspect such as floor plan) and the lifestyle of the customer (soft aspect such as thoughts on the lifestyle of the customer (including thoughts on the residence space of the customer)). The information about the lifestyle of the customer is also referred to as lifestyle information.

Hereinafter, these specific data items will be described with reference to FIGS. 20 to 24. In FIGS. 20 to 24, “A”, “B”, and “C” described corresponding to each of data items indicate databases in which data of the data items is stored. Specifically, “A” indicates the application acquisition database 600A, “B” indicates the building database 600B, and “C” indicates the interview observation database 600C.

FIG. 21 is a diagram showing an example of data items of the biometric information belonging to an independence degree/nursing care degree.

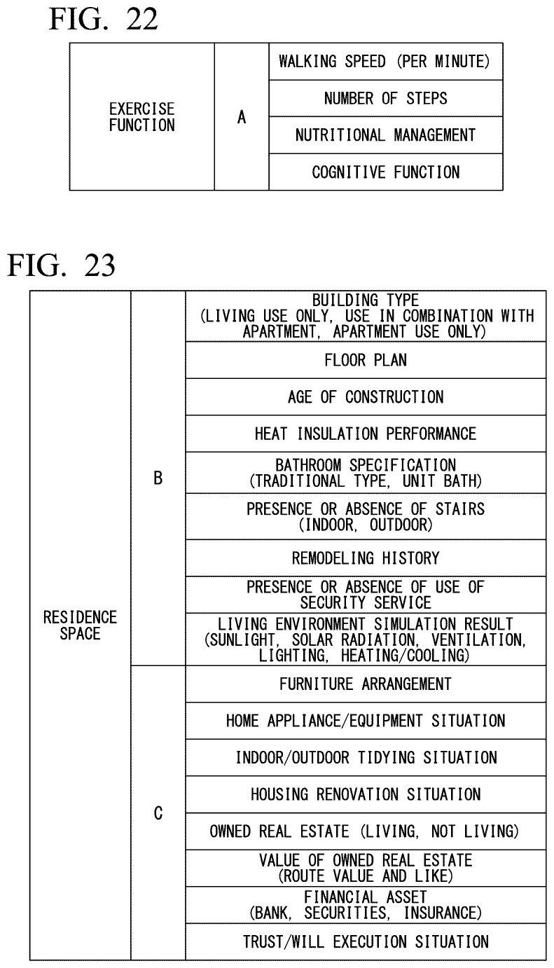

The data items belonging to the independence degree/nursing care degree include nursing care requirement certification, current illness history, hospital visit destination, medical history, medications/supplements, height/weight, blood type, exercise/movement/motion check, thermal sensation, and sleeping situation. FIG. 22 is a diagram showing an example of data items of the biometric information belonging to the exercise function. The data items belonging to the exercise function are a walking speed (per minute), the number of steps, nutritional management, and cognitive function.

FIG. 23 is a diagram showing an example of data items of the living information belonging to the residence space. The data items belonging to the residence space are a building type (residence use only, use in combination with apartment, apartment use only), a floor plan, an age of construction, heat insulation performance, a bathroom specification (traditional type, unit bath), presence or absence of stairs (indoor, outdoor), a remodeling history, presence or absence of use of a security service, a living environment simulation result (sunlight, solar radiation, ventilation, lighting, heating/cooling), furniture arrangement, a home appliance/equipment situation, an indoor/outdoor tidying situation, a housing renovation situation, an owned real estate (living, not living), a value of an owned real estate (route value and the like), a financial asset (bank, securities, insurance), and a trust/will implementation situation.

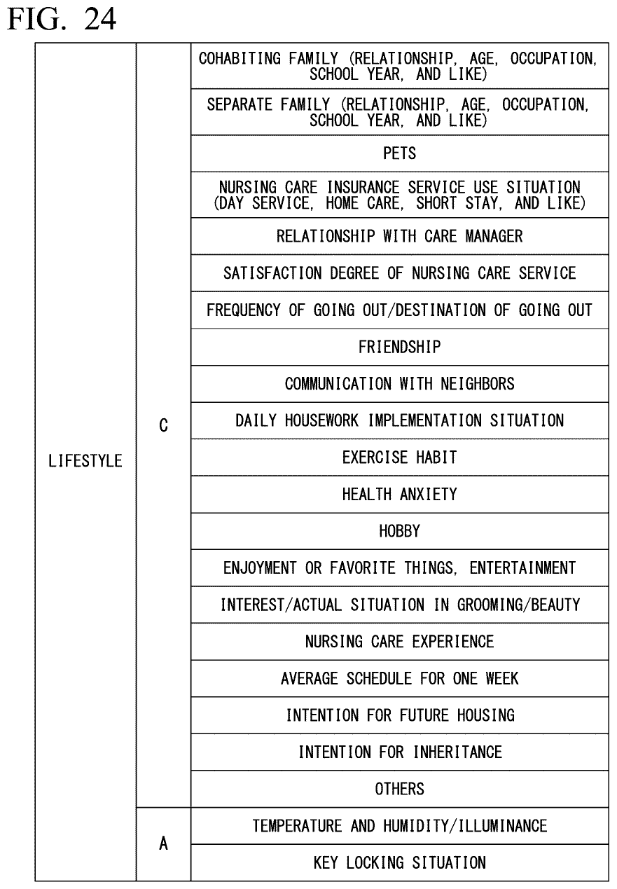

FIG. 24 is a diagram showing an example of data items of the living information belonging to the lifestyle. The data items belonging to the lifestyle include cohabiting family (relationship, age, occupation, school year, and the like), separate family (relationship, age, occupation, school year, and the like), pets, a nursing care insurance service usage status (day service, home care, short stay, and the like), a relationship with a care manager, a satisfaction degree of nursing care service, a frequency of going out/destination of going out, friendship, communication with neighbors, a daily housework implementation situation, exercise habit, health anxiety, hobby, enjoyment or favorite things, entertainment, interest/actual situation in grooming/beauty, a nursing care experience, an average schedule for one week, intention for future housing, intention for inheritance, others, temperature and humidity/illuminance, and key locking situation.

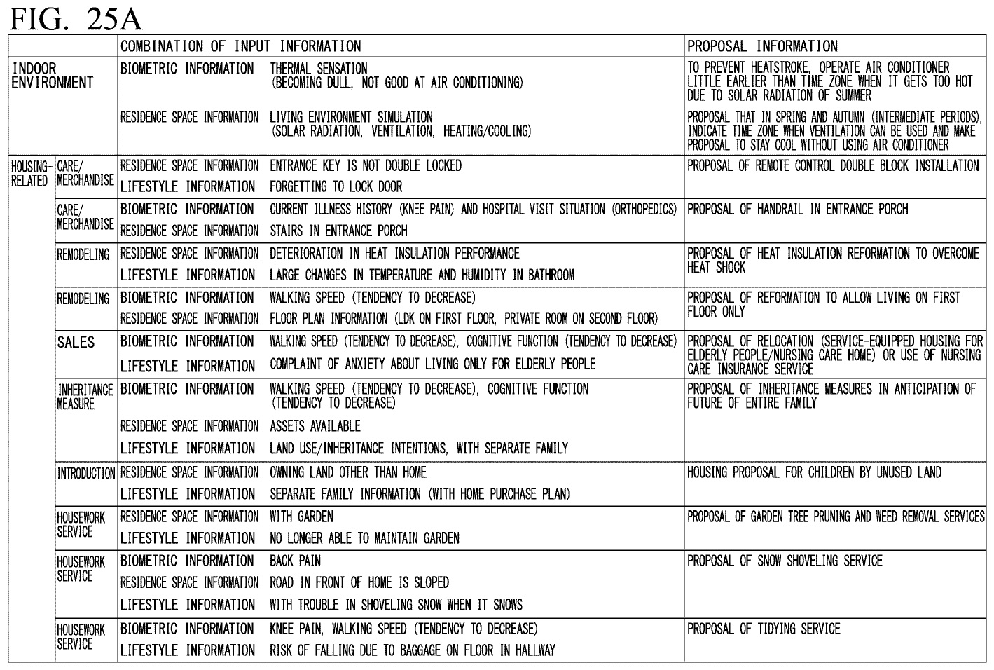

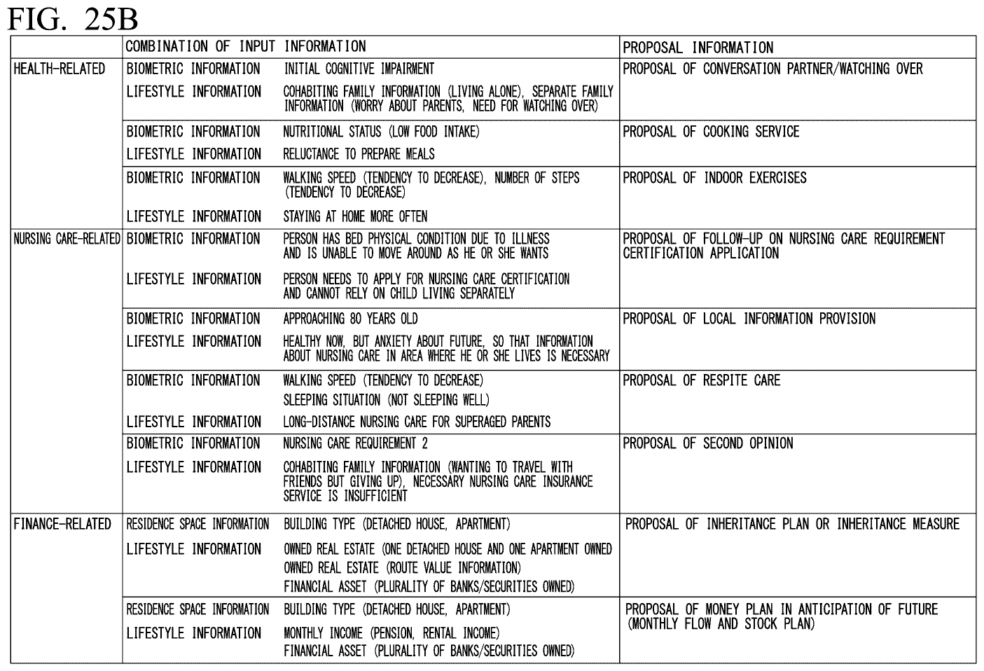

FIGS. 25A and 25B are diagrams showing examples of data contents of the analysis database 600E. The analysis database 600E includes a combination of the input information and the proposal information corresponding to the combination. FIG. 25A shows one example of an indoor environment proposal example and 10 examples of a housing environment proposal example, and FIG. 25B shows three examples of the health-related proposal example, four examples of the nursing care-related proposal example, and two examples of the finance-related proposal example.

First, the indoor environment proposal example and the housing environment proposal examples will be described using FIG. 25A. As the indoor environment proposal example, when the combination of the input information is the biometric information (thermal sensation (becoming dull, not good at air conditioning)) and the residence space information (living environment simulation (solar radiation, ventilation, heating/cooling)), the analysis unit 523 derives, as proposal information, “To prevent heatstroke, operate the air conditioner a little earlier than the time zone when it gets too hot due to the solar radiation of the summer. In spring and autumn (the intermediate periods), indicate the time zone when the ventilation can be used and make a proposal to stay cool without using the air conditioner”. As described above, it is possible to provide information about air conditioning in the indoor space in which the customer resides as the proposal information.

As the housing environment proposal example, when the combination of the input information is the residence space information (entrance key is not double locked) and the lifestyle information (forgetting to lock the door), the analysis unit 523 derives “proposal of remote control double lock installation” as the proposal information. As described above, it is possible to provide information about equipment that assists the life of the customer in the residence space as the proposal information.

As the housing environment proposal example, when the combination of the input information is the biometric information (current illness history (knee pain) and hospital visit situation (orthopedics)) and the residence space information (stairs in the entrance porch), the analysis unit 523 derives “proposal of installation of a handrail in the entrance porch” as the proposal information. As described above, it is possible to provide information about equipment that assists the life of the customer in the residence space as the proposal information.

As the housing environment proposal example, when the combination of the input information is the residence space information (deterioration in heat insulation performance) and the lifestyle information (large changes in temperature and humidity in the bathroom), the analysis unit 523 derives “proposal of heat insulation reformation” as the proposal information. As described above, it is possible to provide information about equipment that assists the life of the customer in the residence space as the proposal information.

As the housing environment proposal example, when a combination of the input information is the biometric information (walking speed (tendency to decrease)) and the residence space information (floor plan information (LDK on the first floor, private room on the second floor)), the analysis unit 523 derives “proposal of reformation to allow living on the first floor only” as the proposal information. As described above, it is possible to provide information about equipment that assists the life of the customer in the residence space as the proposal information.

As the housing environment proposal example, when a combination of the input information is the biometric information (walking speed (tendency to decrease)) and the residence space information (floor plan information (LDK on the first floor, private room on the second floor)), the analysis unit 523 derives “proposal of reformation to allow living on the first floor only” as the proposal information. As described above, it is possible to provide information about equipment that assists the life of the customer in the residence space as the proposal information.

As the housing environment proposal example, when the combination of the input information is the biometric information (walking speed (tendency to decrease) and cognitive function (tendency to decrease)) and the lifestyle information (complaint of anxiety about living only for elderly people), the analysis unit 523 derives “proposal of relocation (service-equipped housing for elderly people/nursing care home) or use of nursing care insurance service” as the proposal information. As described above, it is possible to provide information about nursing care of the customer as the proposal information.

As the housing environment proposal example, when the combination of the input information is the biometric information (walking speed (tendency to decrease) and the cognitive function (tendency to decrease) and the residence space information (floor plan information (assets available), and the lifestyle information (land use/inheritance intentions, with separate family), the analysis unit 523 derives “proposal of inheritance measures in anticipation of the future of the entire family” as the proposal information. As described above, it is possible to provide information about the inheritance of the customer as the proposal information. In addition, the analysis unit 523 can also make a proposal by a combination of three information of the biometric information, the residence space information, and the lifestyle information.

As the housing environment proposal example, when the combination of the input information is the residence space information (owning land other than the home) and the lifestyle information (separate family information (with home purchase plan)), the analysis unit 523 derives “housing proposal for children by an unused land” as the proposal information. As described above, it is possible to provide information about the assets of the customer as the proposal information.

As the housing environment proposal example, when the combination of the input information is the residence space information (with a garden) and the lifestyle information (no longer able to maintain the garden), the analysis unit 523 derives “proposal of the garden tree pruning and weed removal services” as the proposal information. As described above, it is possible to provide information about a service that assists the life of the customer in the residence space as the proposal information.

As the housing environment proposal example, when the combination of the input information is the biometric information (back pain), the residence space information (the road in front of the home is sloped), and the lifestyle information (with a trouble in shoveling snow when it snows), the analysis unit 523 derives “proposal of a snow shoveling service” as the proposal information. As described above, it is possible to provide information about a service that assists the life of the customer in the residence space as the proposal information.

As the housing environment proposal example, when the combination of the input information is the biometric information (knee pain, walking speed (tendency to decrease)) and the lifestyle information (risk of falling due to a baggage on the floor in the hallway), the analysis unit 523 derives “proposal of a tidying service” as the proposal information. As described above, it is possible to provide information about a service that assists the life of the customer in the residence space as the proposal information.

Next, the health-related proposal example, the nursing care-related proposal example, the finance-related proposal example, and the indoor environment proposal example will be described with reference to FIG. 25B. As the health-related proposal example, when the combination of the input information is the biometric information (initial cognitive impairment), the lifestyle information (cohabiting family information (living alone) and separate family information (worry about parents, need for watching over)), the analysis unit 523 derives “proposal of conversation partner/watching over” as the proposal information. As described above, it is possible to provide information about a service that assists the life of the customer in the residence space as the proposal information.

As the health-related proposal example, when the combination of the input information is the biometric information (nutritional status (low food intake)) and the lifestyle information (reluctance to prepare meals), the analysis unit 523 derives “proposal of a cooking service” as the proposal information. As described above, it is possible to provide information about a service that assists the life of the customer in the residence space as the proposal information.

As the health-related proposal example, when the combination of the input information is the biometric information (walking speed (tendency to decrease), the number of steps (tendency to decrease)), and the lifestyle information (staying at home more often), the analysis unit 523 derives “proposal of indoor exercises” as the proposal information. As described above, it is possible to provide information about the improvement of the health of the customer as the proposal information.

As the nursing care-related proposal example, when the combination of the input information is the biometric information (the person has a bad physical condition due to illness and is unable to move around as he or she wants) and the lifestyle information (the person needs to apply for nursing care certification and cannot rely on a child living separately), the analysis unit 523 derives “proposal of follow-up on nursing care requirement certification application” as the proposal information. As described above, it is possible to provide information about nursing care of the customer as the proposal information.

As the nursing care-related proposal example, when the combination of the input information is the biometric information (approaching 80 years old) and the lifestyle information (healthy now, but anxiety about the future, so that information about nursing care in an area where he or she lives is necessary), the analysis unit 523 derives “proposal of local information provision” as the proposal information. As described above, it is possible to provide information about nursing care of the customer as the proposal information.

As the nursing care-related proposal example, when the combination of the input information is the biometric information (walking speed (tendency to decrease), sleeping situation (not sleeping well), and the lifestyle information (long-distance nursing care for superaged parents), the analysis unit 523 derives “proposal of respite care” as the proposal information. As described above, it is possible to provide information about the improvement of the health of the customer as the proposal information.

As the nursing care-related proposal example, when the combination of the input information is the biometric information (nursing care requirement 2) and the lifestyle information (cohabiting family information (wanting to travel with friends but giving up), and the necessary nursing care insurance service is insufficient (short stay)), the analysis unit 523 derives “proposal of a second opinion” as the proposal information. As described above, it is possible to provide information about nursing care of the customer as the proposal information.

As the finance-related proposal example, when the combination of the input information is the residence space information (building type (detached house, apartment)) and the lifestyle information (owned real estate (one detached house and one apartment owned, owned real estate (route value information), and financial asset (a plurality of banks/securities owned)), the analysis unit 523 derives “proposal of inheritance plan or inheritance measure” as the proposal information. As described above, it is possible to provide information about the inheritance of the customer as the proposal information. It should be noted that “a plurality of banks/securities owned” in the financial information indicates that a plurality of bank deposits, postal savings, securities, and the like are owned.

As the finance-related proposal example, when the combination of the input information is the residence space information (building type (detached house, apartment)) and the lifestyle information (monthly income (pension, rental income), financial asset (a plurality of banks/securities owned)), the analysis unit 523 derives “proposal of money plan in anticipation of the future (monthly flow and stock plan)” as the proposal information. As described above, it is possible to provide information about the asset as the proposal information.

As described above, the information management system 5 can derive and output information about the proposal of the QOL by using various information such as the biometric information and the living information. In addition, all of the proposals are for maintaining the QOL of the customer or improving the quality of life of the customer.

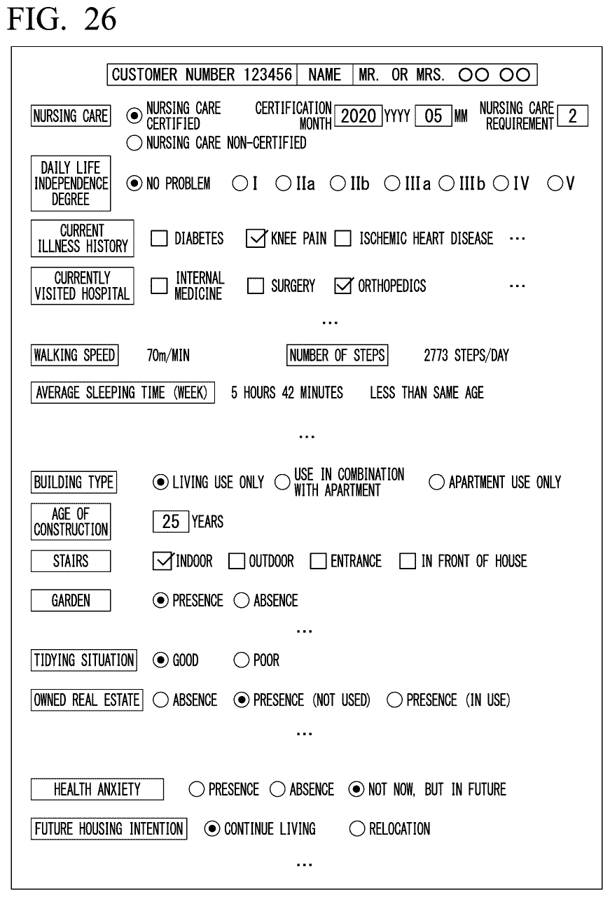

Next, an input screen for the biometric information and the living information will be described. FIG. 26 is a diagram showing an example of the input screen. The input screen is displayed on the display unit 512. In the input screen, an input field is provided for each data item of the biometric information and the living information. The advisor selects the corresponding item using a radio button or a check box, or inputs the corresponding item in a text box. For example, when the nursing care is certified in “nursing care”, the advisor selects a radio button of “nursing care certified” and inputs a certification month or a nursing care requirement level in the text box. In addition, a daily life independence degree input field is provided as information about a fact recognition ability. In the daily life independence degree input field, a field for inputting the daily life independence degree and a field for inputting no problem when there is no problem are provided.

On the other hand, the information acquired by the device is automatically displayed. For example, a “walking speed” or “number of steps” acquired by the device is automatically displayed.

In the input screen shown in FIG. 26, the information input by the advisor is stored in the database 600.

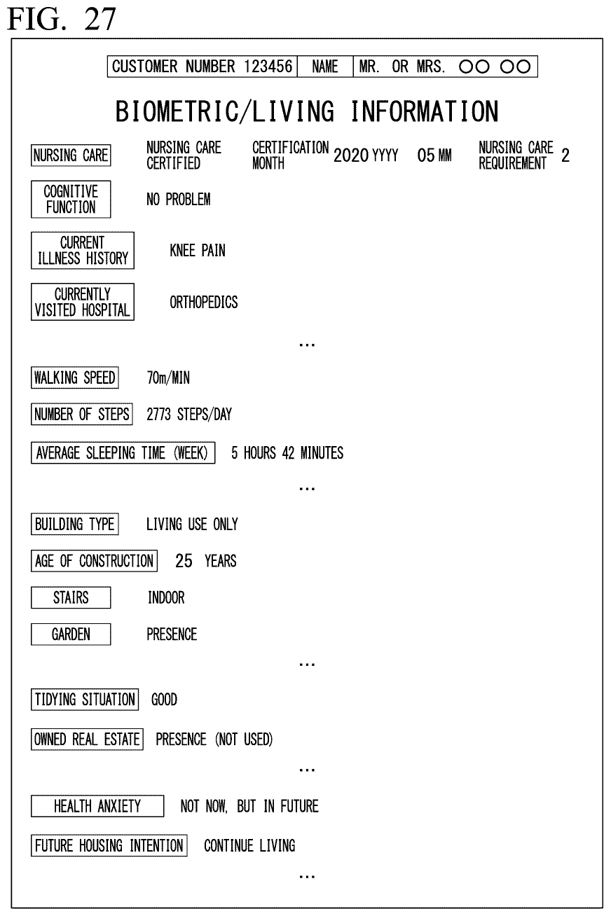

FIG. 27 is a diagram showing an example of biometric/living information. The biometric/living information can be displayed on the display unit 512 or printed. The biometric/living information is output by associating the biometric information and the living information with a customer number of the customer. Specifically, as shown in FIG. 27, the information input by the advisor or the information acquired by the device is summarized, and the biometric information and the living information are output.

By outputting the summarized biometric information and living information such as the biometric/living information shown in FIG. 27, the advisor can summarize and overview various information. Therefore, the information management system 5 according to the present embodiment can provide information about the proposal for maintaining and improving the QOL.

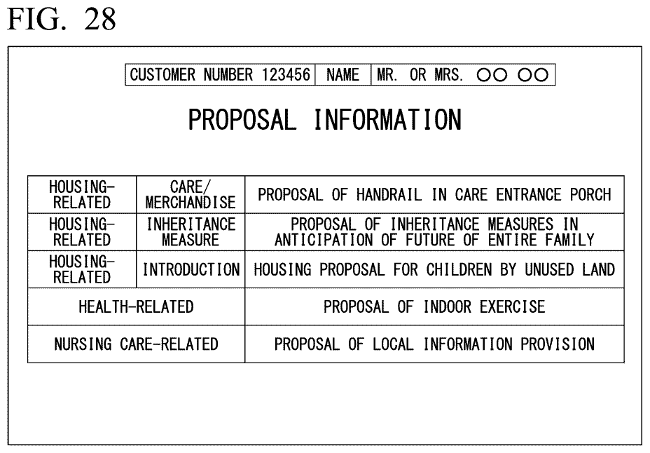

FIG. 28 is a diagram showing an example of the proposal information. As described above, the proposal information can be displayed on the display unit 512 or printed. The proposal information is information in which the analysis unit 523 performs analysis based on the combination of the biometric information and the living information and derives the proposal information for maintaining the quality of life of the customer or improving the quality of life of the customer. In addition, the proposal information is output in association with a customer number of the customer.

As shown in FIG. 28, the proposal information is displayed for each item, such as “housing-related information” or “health-related information”. Then, the proposal information is displayed for each item. Since the advisor can advise the customer with reference to the output proposal information, even a new advisor can provide an accurate advice to the customer.

The information indicating the fact recognition ability of the customer may be input, and the analysis unit 523 may derive the independence degree and the nursing care degree as the proposal information based on the fact recognition ability of the customer and the exercise function of the customer.

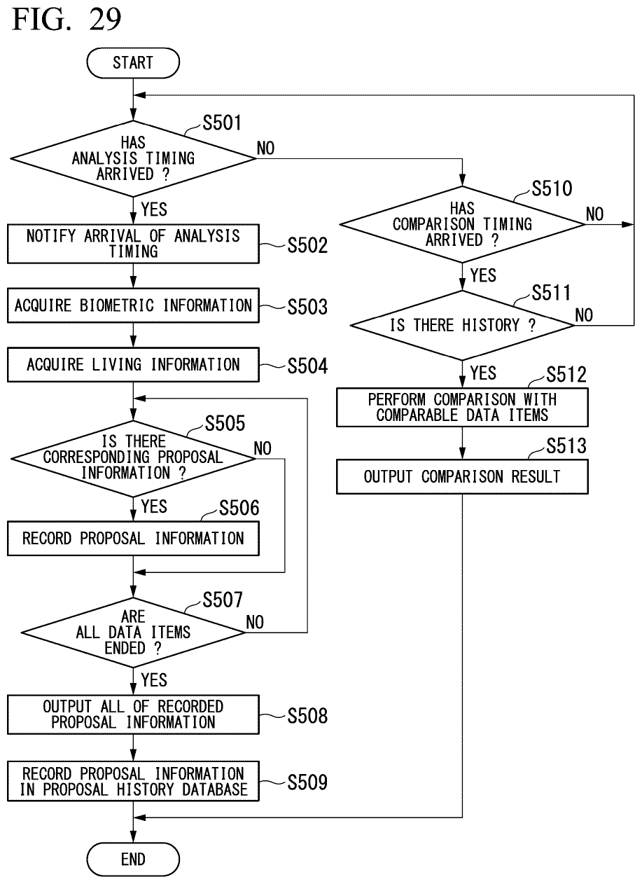

Next, a flow of processing of the information management system 5 will be described. FIG. 29 is a flowchart showing a flow of processing of the information management system 5. The timing generation unit 524 determines whether or not the analysis timing has arrived (step S501). When the analysis timing has arrived (step S501: YES), the timing generation unit 524 notifies the analysis unit 523 that the analysis timing has arrived (step S502).

The analysis unit 523 that is notified that the analysis timing has arrived acquires the biometric information from the database 600 (step S503) and acquires the living information (step S504).

The analysis unit 523 determines whether or not there is the corresponding proposal information in the analysis database 600E with a combination of the data items of the acquired biometric information and living information (step S505). When there is no proposal information corresponding to the combination (step S505: NO), the analysis unit 523 proceeds to step S507.

When there is the proposal information corresponding to the combination (Step S505: YES), the analysis unit 523 records the corresponding proposal information (Step S506). The analysis unit 523 determines whether or not the determination as to whether or not there is the proposal information corresponding to the combination is ended for all the data items (step S570). When the determination as to whether or not there is the proposal information corresponding to the combination for all the data items is not ended (Step S507: NO), the analysis unit 523 performs the determination again in step S505 for the data item that has not been determined.

When the determination as to whether or not there is the proposal information corresponding to the combination for all the data items is ended (step S507: YES), the analysis unit 523 outputs the proposal information recorded in step S506 (step S508), and records the proposal information, the biometric information, and the living information in the proposal history database 600D (step S509) to end this processing. When there is no proposal information, the proposal information is not output, and in the proposal history database 600D, it is recorded that there is no proposal information, the biometric information, and the living information in the current analysis.

In step S501, when the analysis timing has not arrived (step S501: NO), the comparison unit 525 determines whether or not a comparison timing has arrived (step S510). Here, examples of the comparison timing include a regular timing such as once a week, a timing at which new living information is input, and a timing at which a comparison instruction from the advisor is input. When the comparison timing has not arrived (step S510: NO), the processing returns to step S501.

When the comparison timing has arrived (step S510: YES), the comparison unit 525 determines whether or not there is a history in the proposal history database 600D (step S511). When there is no history (step S511: NO), there is no comparison target, and thus the processing returns to step S501. When there is the history (step S511: YES), the comparison unit 525 performs the comparison with comparable data items (step S512). Examples of the comparable data items include a sleeping time and the presence or absence of illness (for example, no back pain). The comparison unit 525 outputs the comparison result (step S513), and the processing is ended. The comparison result is output to the display unit 512 by, for example, the display control unit 521 or is output as a printed matter by a printer (not shown).

When the above-described analysis timing occurs, the proposal information is derived. Therefore, the analysis timing is a timing for the advisor to make a proposal to the customer, but for example, the analysis timing may be a timing for performing analysis. Then, a timing of outputting the proposal information after the analysis may be set as a proposal timing.

In the above-described embodiment, for example, even when it is analyzed that the handrail is necessary, when the customer intends to move to any place, it is possible not to output a proposal that the handrail is necessary. That is, when only the residence space (hard aspect) is focused, the handrail is necessary, which is certainly a partial optimum, but in the present embodiment, it is possible to make an overall optimum proposal by considering the soft aspect.

In addition, information about a medical institution, an osteopathic clinic, or the like may be accumulated, and a more appropriate proposal may be made. Specifically, in a case of the back pain, a proposal such as introducing an osteopathic clinic and orthopedics that is affiliated with the osteopathic clinic may be output.

Further, information about a real estate company may be accumulated to make a more appropriate proposal. For example, in a case of a consultation only on the land, a proposal may be output to introduce a real estate company A that has performed a large number of transactions only on the land, and in a case of a consultation on the land and the building, a proposal may be output to introduce a real estate company B that has performed a large number of transactions on the land and the building.

Regarding the financial asset, information about a bank or securities company may be accumulated, and a proposal may be output to introduce a bank having more know-how related to inheritance in a case of a consultation related to inheritance.

Further, a proposal in consideration of a human relationship may be introduced. For example, “housing proposal for children by an unused land” is listed as a proposal candidate, but the proposal may not be output when a relationship with the child is not good.

In the above-described embodiment, the customer is assumed to be an individual of a so-called senior generation or middle generation, but the biometric information and the living information are information that can be acquired from any generation. Therefore, the above-described embodiment may be applied to customers other than the senior generation and the middle generation.

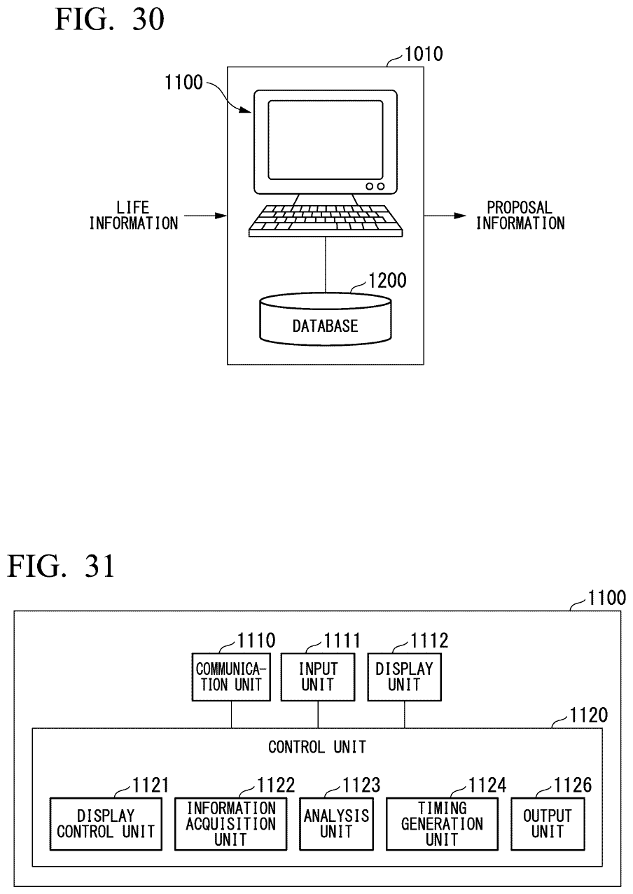

FIG. 30 is a diagram schematically showing a device configuration and a use environment of an information management system 1010 according to the embodiment. A terminal 1100 constituting the information management system 1010 acquires life information of a subject. The life information includes an event described below in addition to personal information, building information, and money information shown in FIG. 30. In addition, the personal information is information about the subject and includes biometric information and living information. The biometric information is information about the independence degree and the nursing care degree of the subject and the exercise function of the customer. The living information indicates information about the living of the subject. The building information indicates information about a residence space (hard aspect such as a floor plan) of the subject, an external space of the residence space, a surrounding environment of the residence space, and a location of the residence space. The money information indicates information about money associated with a residence in which the subject resides or a residence in which the family of the subject resides.

The terminal 1100 generates timing information about a timing of a change in life of the subject based on the acquired life information. In addition, the terminal 1100 derives and outputs proposal information for improving the quality of life (hereinafter, referred to as “QOL”) of the subject by performing the analysis using the database 1200 based on the acquired life information. The output proposal information is proposed to the subject by, for example, the advisor. The database 1200 is stored in a cloud, a database server, or the like.

FIG. 31 is a functional block diagram showing a functional configuration of the terminal 1100. The terminal 1100 includes a central processing unit (CPU), a memory, an auxiliary storage device, and the like connected by a bus, and functions as a device including a communication unit 1110, an input unit 1111, a display unit 1112, and a control unit 1120 by executing an information management program.

The communication unit 1110 performs communication for acquiring information from the database 1200. The input unit 1111 is configured by using an input device such as a touch panel, a mouse, and a keyboard. The input unit 1111 may be an interface for connecting an input device to the terminal 1100. In this case, the input unit 1111 generates input data (for example, instruction information indicating an instruction to the terminal 1100) from an input signal that is input by the input device, and inputs the input data to the terminal 1100.

The display unit 1112 is an output device such as a cathode ray tube (CRT) display, a liquid crystal display, or an organic electro luminescence (EL) display. The display unit 1112 may be an interface for connecting the output device to the terminal 1100. In this case, the display unit 1112 generates a video signal from video data and outputs the video signal to a video output device connected to the display unit 1112.

All or some of the functions of each of the communication unit 1110 and the control unit 1120 may be realized by using hardware such as an application specific integrated circuit (ASIC), a programmable logic device (PLD), or a field programmable gate array (FPGA).

The information management program may be recorded on a computer-readable recording medium. For example, the computer-readable recording medium is a portable medium such as a flexible disk, a magneto-optical disk, a ROM, and a CD-ROM, or a storage device such as a hard disk built in a computer system. The information management program may be transmitted via an electric communication line.

The control unit 1120 in FIG. 31 controls an operation of each unit of the terminal 1100. The control unit 1120 is executed by a device including, for example, a processor such as a CPU and a RAM. The control unit 1120 executes the information management program to function as a display control unit 1121, an information acquisition unit 1122, an analysis unit 1123, a timing generation unit 1124, and an output unit 1126.

The display control unit 1121 controls the entire screen displayed on the display unit 1112. The information acquisition unit 1122 acquires the life information by acquiring the information from the database 1200 or acquiring the information input by the input unit 1111. The analysis unit 1123 performs analysis based on the acquired life information and derives the proposal information for maintaining the quality of life of the subject or improving the quality of life of the subject. The derived proposal information is output to the display unit 1112 by the output unit 1126, for example, the display control unit 1121, or is output as a printed matter by a printer (not shown).

The timing generation unit 1124 generates a timing at which the information acquisition unit 1122 acquires the life information, a timing at which the analysis unit 1123 derives the proposal information, or a timing at which the output unit 1126 outputs the proposal information, based on the life information acquired by the information acquisition unit 1122.

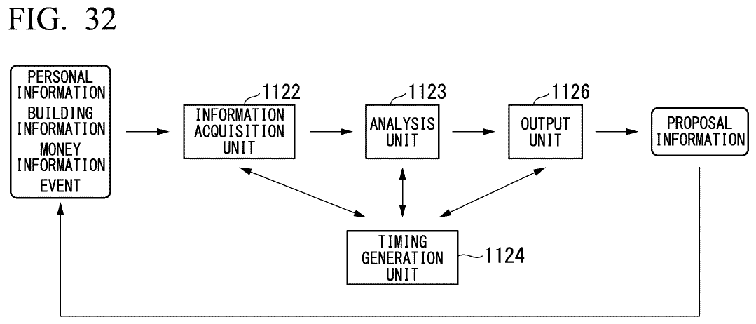

FIG. 32 is a diagram schematically showing a flow of information and an output of the timing generation unit 1124. First, as described above, the timing generation unit 1124 generates the timing at which the information acquisition unit 1122 acquires the life information, and outputs the generated timing to the information acquisition unit 1122. The timing generation unit 1124 generates the timing at which the analysis unit 1123 derives the proposal information, and outputs the generated timing to the analysis unit 1123. The timing generation unit 1124 generates the timing at which the output unit 1126 outputs the proposal information, and outputs the generated timing to the output unit 1126.

The information acquisition unit 1122 acquires the life information at the timing generated by the timing generation unit 1124 or acquires the life information at a timing at which the life information is input from the input unit 1111. The analysis unit 1123 performs analysis using the database 1200 based on the life information at the timing at which the life information is input from the information acquisition unit 1122 or the timing generated by the timing generation unit 1124, and derives the proposal information for improving the QOL of the subject to output the proposal information. The output unit 1126 outputs the proposal information at the timing at which the proposal information is input from the analysis unit 1123 or at the timing generated by the timing generation unit 1124.

The output proposal information is provided through the advisor to the subject or the like from a care manager in charge of the subject or the close relative (for example, the parents of the subject, the spouse of the subject, the children of the subject, the grandchildren of the subject, or the like). The life information is changed by a behavior of the subject or the like in response to the proposal information. The changed life information is input to the information acquisition unit 1122 again, and new proposal information suitable for the changed life information is output. By repeating this, it is possible to maintain or improve the QOL of the subject.

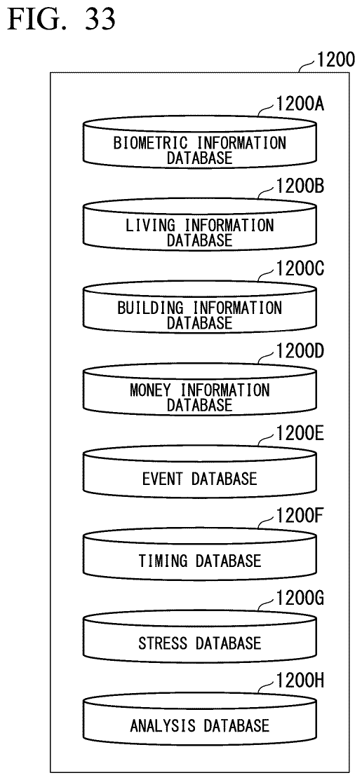

FIG. 33 is a diagram showing the database 1200. The database 1200 includes a biometric information database 1200A, a living information database 1200B, a building information database 1200C, a money information database 1200D, an event database 1200E, a timing database 1200F, a stress database 1200G, and an analysis database 1200H. The database 1200 is provided for each subject and is stored in association with a subject number (individual recognition information) that uniquely indicates the subject.

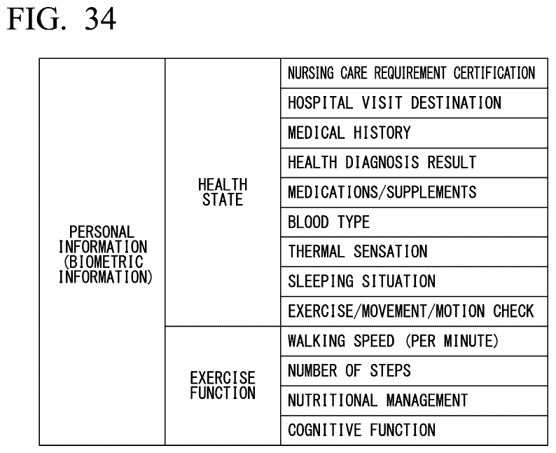

A biometric information database 1200A is a database that records the biometric information. FIG. 34 is a diagram showing an example of the biometric information recorded in a biometric information database. The biometric information includes a health state and an exercise function. The data items belonging to the health state include nursing care requirement certification, hospital visit destination, medical history, health diagnosis result, medications/supplements, blood type, thermal sensation, sleeping situation, and exercise/movement/motion check. The data items belonging to the exercise function are a walking speed (per minute), the number of steps, nutritional management, and cognitive function.

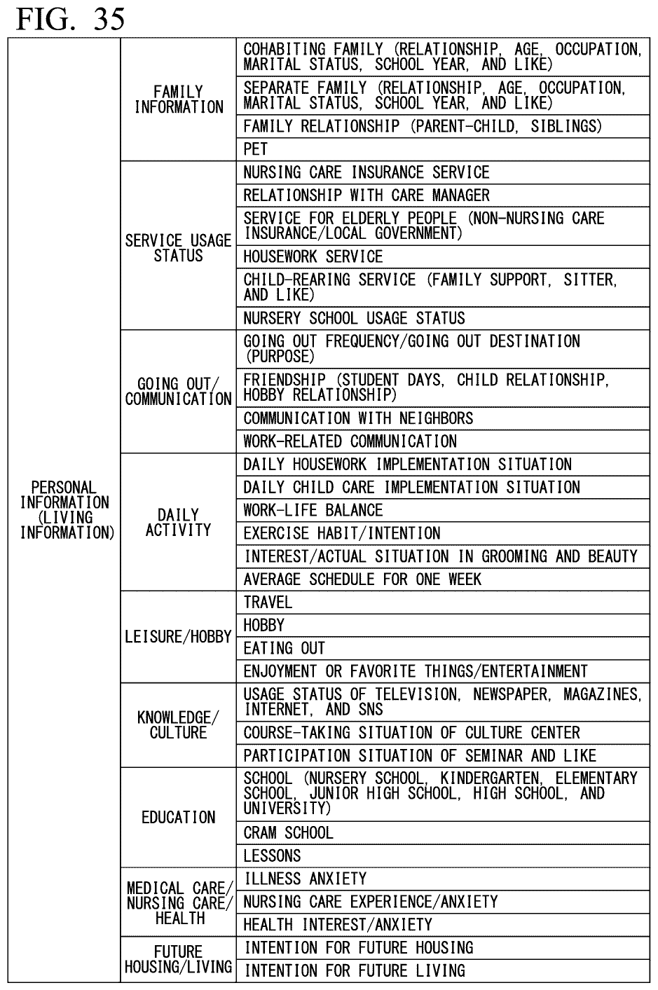

The living information database 1200B is a database that records the living information. FIG. 35 is a diagram showing an example of the living information recorded in the living information database. The living information includes family information, service usage status, going out/communication, daily activity, leisure/hobby, knowledge/culture, education, medical care/nursing care/health, and future housing/living.

The data items belonging to the family information are cohabiting family (relationship, age, occupation, marital status, school year, and the like), separate family (relationship, age, occupation, marital status, school year, and the like), family relationship (parent-child, siblings), and pet. The data items belonging to the service usage status are a nursing care insurance service, a relationship with the care manager, a service for the elderly people (non-nursing care insurance/local government), a housework service, a child rearing service (family support, sitter, and the like), and nursery school usage status.

The data items belonging to the going out/communication are going out frequency/going out destination (purpose), friendship (student days, child relationship, hobby relationship), communication with neighbors, and work-related communication. The data items belonging to the daily activity are daily housework implementation situation, daily child rearing implementation situation, work-life balance, exercise habit/intention, interest/actual situation in grooming/beauty, and average schedule for one week. The data items belonging to the leisure/hobby are travel, hobby, eating out, enjoyment or favorite things, and entertainment.

The data items belonging to the knowledge/culture are a usage status of television, newspaper, magazines, the Internet, and SNS, a course-taking situation of culture center, and a participation situation of seminar and the like. The data items belonging to the education are school (nursery school, kindergarten, elementary school, junior high school, high school, and university), cram school, and lessons. The data items belonging to the medical care/nursing care/health are illness anxiety, nursing care experience/anxiety, and health interest/anxiety.

The data items belonging to the future housing/living are an intention for the future housing and an intention for the future living.

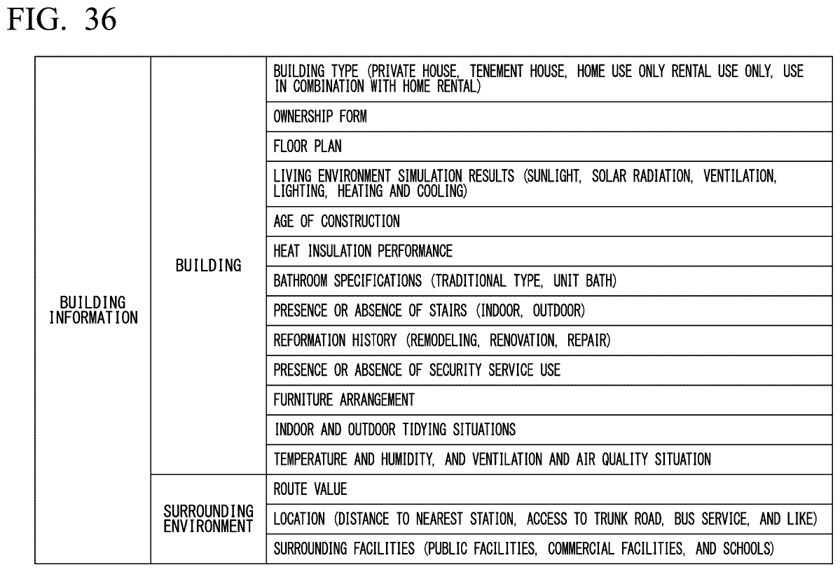

The building information database 1200C is a database that records the building information. FIG. 36 is a diagram showing an example of the building information recorded in the building information database. The building information includes a building and a surrounding environment.

The data items belonging to the building are building type (private house, tenement house, home use only, rental use only, use in combination with home rental), ownership form, floor plan, living environment simulation results (sunlight, solar radiation, ventilation, lighting, heating and cooling), an age of construction, heat insulation performance, bathroom specifications (traditional type, unit bath), presence or absence of stairs (indoor, outdoor), reformation history (remodeling, renovation, repair), presence or absence of security service use, furniture arrangement, indoor and outdoor tidying situations, temperature and humidity, and ventilation/air quality situation.

The data items belonging to the surrounding environment are a route value, a location (a distance to the nearest station, an access to a trunk road, a bus service, and the like), and surrounding facilities (public facilities, commercial facilities, and schools).

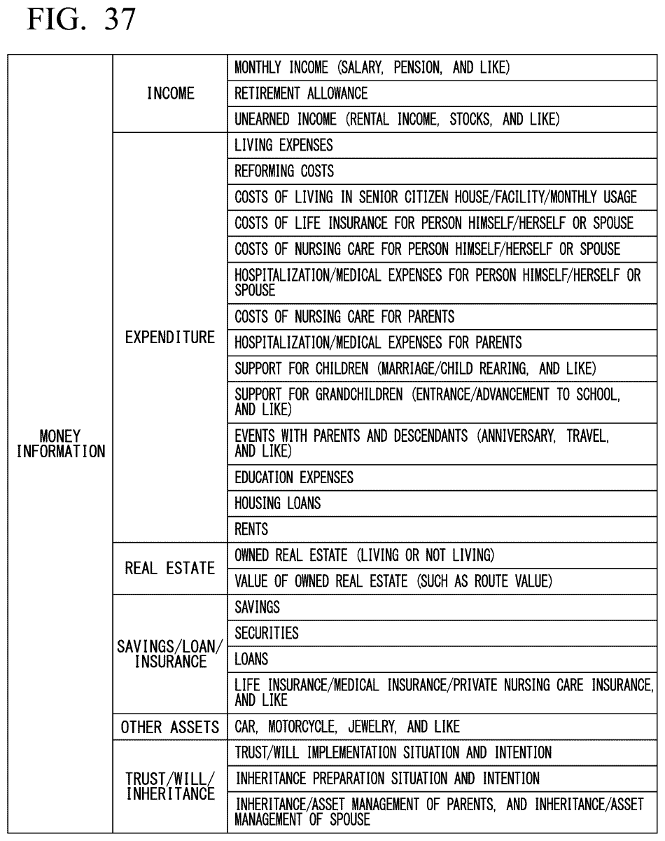

The money information database 1200D is a database that records the money information. FIG. 37 is a diagram showing an example of the money information recorded in the money information database. The money information includes income, expenditure, real estate, savings/loan/insurance, and other asset trust/will/inheritance.

The data items belonging to the income are monthly income (salary, pension, and the like), retirement allowance, and unearned income (rental income, stocks, and the like). The data items belonging to the expenditure are living expenses, reforming costs, costs of living in a senior citizen house/facility/monthly usage, costs of life insurance for the person himself/herself or the spouse, costs of nursing care for the person himself/herself or the spouse, hospitalization/medical expenses for the person himself/herself or the spouse, costs of nursing care for the parents, hospitalization/medical expenses for the parents, support for children (marriage/child rearing, and the like), support for grandchildren (entrance/advancement to school, and the like), events with the parents and descendants (anniversary, travel, and the like), education expenses, housing loans, rents, and the like.

The data items related to the real estate are owned real estate (living or not living), value of owned real estate (such as a route value), and the like. The data items belonging to the savings/loan/insurance are savings, securities, loans, life insurance/medical insurance/private nursing care insurance, and the like. The data items belonging to other assets are a car, a motorcycle, a jewelry, and the like. The data items belonging to trust/will/inheritance are trust/will implementation situation and intention, inheritance preparation situation and intention, inheritance/asset management of parents, and inheritance/asset management of spouse.

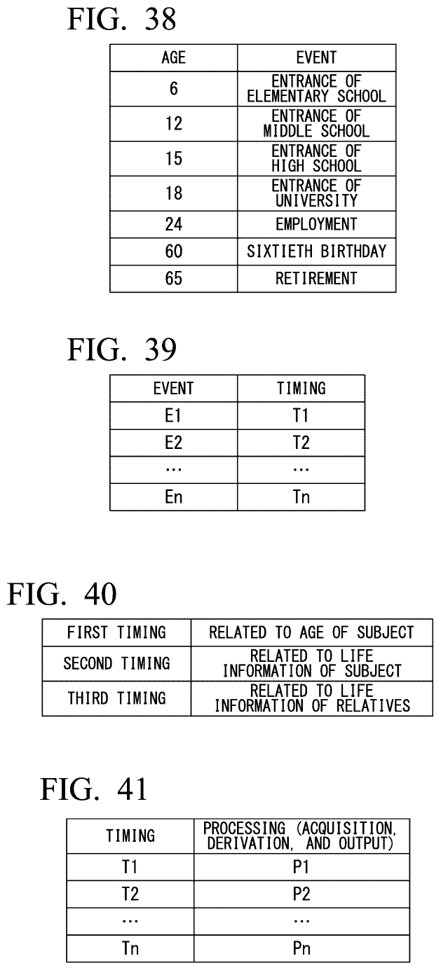

The event database 1200E is a database that records an event and a timing related to the subject. First, the event will be described. FIG. 38 is a diagram showing an example of the event. The event shown in FIG. 38 is a basic event. As shown in FIG. 38, in a general life, events such as school entrance, employment, and a sixtieth birthday occur. In addition, although not shown in FIG. 38, there are various events such as “turning 40 years old” or “turning 75 years old” based only on age, marriage, childbirth, school entrance of child or grandchild, nursing care certification of parents, home purchase, illness, and health checkup result requiring follow-up observation.

A timing is set in association with such an event. For example, there is a pre-sixtieth birthday health checkup timing associated with an event of sixtieth birthday, and there is a maintenance timing associated with the home purchase. Therefore, in the present embodiment, an event database is provided as one of the databases related to the timing.

FIG. 39 is a diagram showing the event database 1200E. In FIG. 39, for example, timings T1 to Tn associated with each of events E1 to En are provided. In FIG. 39, one timing is associated with one event, but a plurality of timings may be associated with one event. For example, two timings of pre-sixtieth birthday health checkup and pre-retirement asset plan creation may be associated with an event of sixtieth birthday.

In addition, as the event suitable for the young age, a timing of a school bag purchase, a study desk purchase, and a pre-school health checkup may be associated with an event of an elementary school entrance. In addition, as the event suitable for the young age, a timing of purchase of a new house or rental house and purchase of furniture may be associated with the event of marriage.

The event itself may serve as the timing. For example, an event of a sixtieth birthday is also a timing of the sixtieth birthday. In this case, a time of occurrence of the event is the same as a time of arrival of the timing.

In the following description, the biometric information database 1200A, the living information database 1200B, the building information database 1200C, the money information database 1200D, and the event database 1200E may be collectively referred to as a life information database.

Next, the classification of the timing will be described. The timing is classified into a first timing, a second timing, and a third timing. FIG. 40 is a diagram showing a definition of the first timing, the second timing, and the third timing. The first timing is a timing associated with an event related to the age of the subject. That is, the first timing is a timing determined by the age of the subject. Examples of the first timing include a sixtieth birthday, retirement, and “turning 75 years old”.

The second timing is a timing associated with an event (excluding the event used in the first timing) related to the life information of the subject, and is a timing determined in accordance with the change in the life information. Examples of the second timing include a follow-up examination, home maintenance, and the like.

The third timing is a timing associated with an event related to the life information of the relative of the subject. Examples of the third timing include the school entrance of a grandchild and a health checkup of a spouse.

The timing described above is stored in the timing database 1200F for each subject. FIG. 41 is a diagram showing the timing database. In FIG. 41, for example, processing P1 to Pn to be executed at each of the timings T1 to Tn are provided. The processing P1 to Pn is any processing of acquisition processing of acquiring information by the information acquisition unit 1122, derivation processing of deriving proposal information by the analysis unit 1123, or output processing of outputting information by the output unit 1126. In FIG. 41, one processing is provided at one timing, but a plurality of processing may be associated with one timing. For example, two timings of pre-sixtieth birthday health checkup and pre-retirement asset plan creation may be associated with an event of sixtieth birthday.

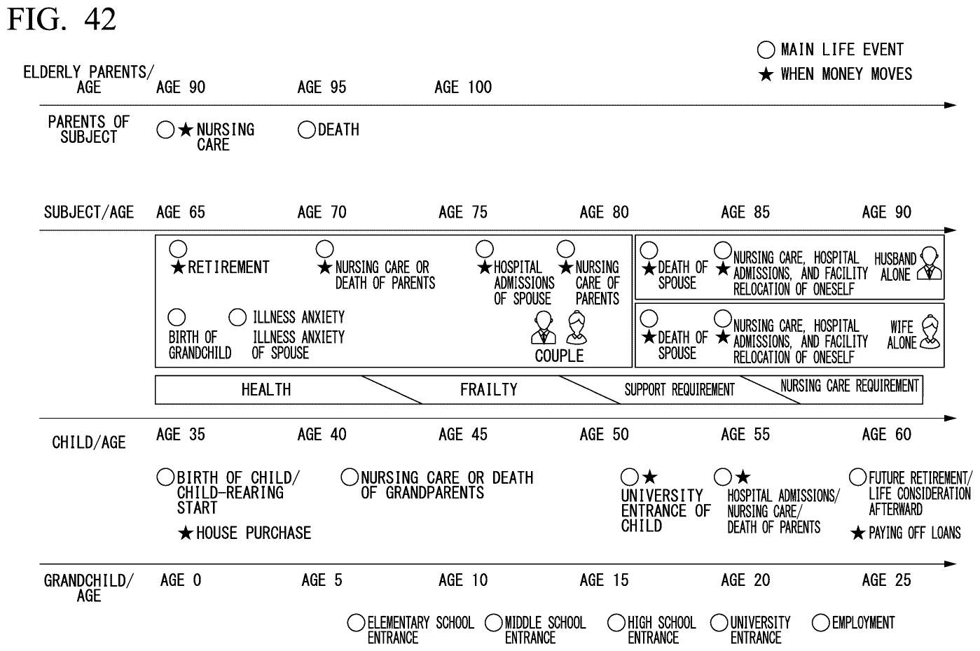

FIG. 42 is a schematic diagram showing contents of the timing database 1200 together with the event. FIG. 42 shows the timing or the event in time series. For example, the age of the subject is 65 years old or older. In addition, the parents, spouse, children, and grandchildren of the subject are shown as the relatives of the subject.

As shown in FIG. 42, the timing database 1200 can record the timing of the subject or the timing of the relative based on the age of the subject, thereby covering various timings related to the subject. As a result, the processing with the arrival of the timing shown in the timing database 1200 is executed, so that it is possible to maintain or improve the QOL of the subject from the present to the future of the subject.

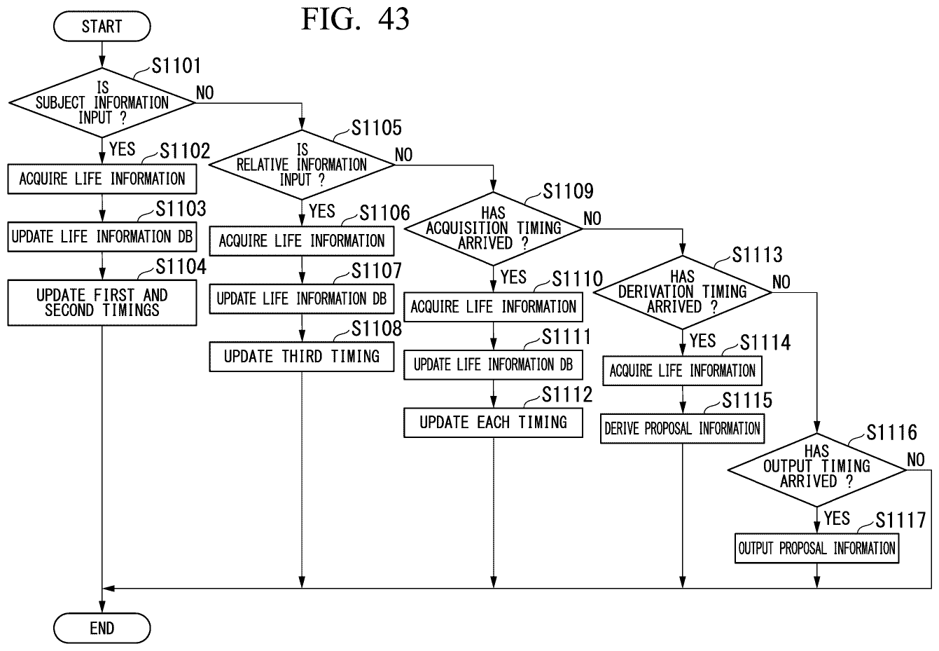

Next, a flow of processing of the information management system 1010 will be described. In the following description, the update of the timing indicates any of addition, deletion, or change of the timing in a timing database 1200F. FIG. 43 is a flowchart showing a flow of processing of the information management system 1010. The flowchart shows processing executed according to each trigger occurring in the information management system 1010. The trigger includes an input of information about the subject, an input of information about the close relative, an arrival of an acquisition timing of the life information by the information acquisition unit 1122, an arrival of a derivation timing by the analysis unit 1123, and an arrival of an output timing by the output unit 1126.

The information management system 1010 determines whether or not the information about the subject is input (step S1101). The information about the subject includes information heard from the subject, information output from a sensor that senses the biometric information, and the like. When the information about the subject is input (step S1101: YES), the information management system 1010 updates the life information database (step S1103) when the information acquisition unit 1122 acquires the input information about the subject as the life information (step S1102). In response to the update, the timing generation unit 1124 updates the first timing and the second timing (step S1104), and the processing is ended.

When the information about the subject is not input in step S1101 (step S1101: NO), the information management system 1010 determines whether or not the information about the relative of the subject is input (step S1105). The information about the relative includes the information heard from the subject. When the information about the relative is input (step S1105: YES), the information management system 1010 updates the life information database (step S1107) when the information acquisition unit 1122 acquires the input information about the relative as the life information (step S1106). In response to this update, the timing generation unit 1124 updates the third timing (step S1108), and the processing is ended.

When the information about the relative is not input in step S1105 (step S1105: NO), the information management system 1010 determines whether or not the acquisition timing of the life information by the information acquisition unit 1122 has arrived (step S1109). The arrival of the acquisition timing is notified to the information acquisition unit 1122 by the timing generation unit 1124. When the acquisition timing of the life information is arrived (step S1109: YES), the information management system 1010 updates the life information database (step S1111) when the information acquisition unit 1122 acquires the life information (step S1110). In response to the update, the timing generation unit 1124 updates each timing in accordance with the updated life information (step S1112), and the processing is ended.

In step S1109, when the acquisition timing has not arrived (step S1109: NO), the information management system 1010 determines whether or not the derivation timing of the proposal information by the analysis unit 1123 has arrived (step S1113). The arrival of the derivation timing is notified to the analysis unit 1123 by the timing generation unit 1124. When the derivation timing of the proposal information has arrived (step S1113: YES), the analysis unit 1123 acquires the life information from the life information database (step S1114) and derives the proposal information (step S1115), and the processing is ended.

In step S1113, when the derivation timing has not arrived (step S1113: NO), the information management system 1010 determines whether or not the output timing by the output unit 1126 has arrived (step S1116). The arrival of the output timing is notified to the analysis unit 1123 by the timing generation unit 1124. When the output timing has arrived (step S1116: YES), the output unit 1126 outputs the proposal information (step S1117), and the processing is ended. When the output timing has not arrived (NO in step S1116), the information management system 1010 returns to step S1101.

As described above, the timing generation unit 1124 generates the first timing determined by the age of the subject and the second timing determined according to the change in the life information. In addition, the timing generation unit 1124 acquires the life information and updates the acquired life information when any one of the first timing or the second timing arrives.

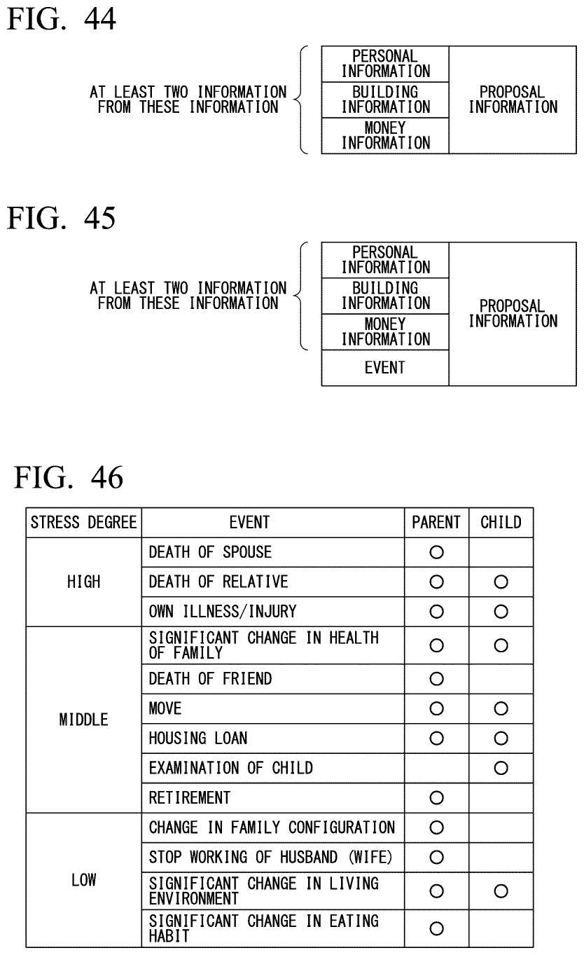

As shown in the processing of the information management system 1010 described above, the timing is updated according to the life information, the change of the event, and the like. A specific processing example will be described. The analysis unit 1123 derives the proposal information by using the analysis database 1200H. The analysis database 1200H is a database that records analysis information. FIGS. 44 and 45 are diagrams showing an example of the analysis information recorded in the analysis database 1200H. As shown in FIGS. 44 and 45, the analysis information is information in which the contents of the life information and the proposal information are associated with each other. As shown in FIG. 44, the analysis information includes information in which the proposal information is associated with at least two information of the personal information, the building information, and the money information. Further, as shown in FIG. 45, the analysis information includes information in which the proposal information is associated with at least two information of the personal information, the building information, and the money information, and the event.

The analysis unit 1123 searches for analysis information that matches the acquired life information, and derives the proposal information indicated by the searched analysis information.

Based on this, first, processing using the personal information, the building information, and the money information among the life information will be described. In the following description, the personal information, the building information, and the money information may be collectively referred to as non-event information.

First, a processing example using a combination of two information (personal information and building information) among the non-event information will be described. It is assumed that a change of “hospitalized and walking with a cane, and received nursing care requirement certification” occurs in the personal information. It is assumed that “there are five steps in the entrance approach” is recorded as the building information, and “wanting to go out (day service, lunch with friends, shopping with grandchildren)” is recorded as the living information. In this case, the timing generation unit 1124 notifies the analysis unit 1123 that an analysis timing has arrived. The analysis unit 1123 derives the housing renovation from the information as the proposal information. In this case, the advisor can smoothly apply for the nursing care requirement by consulting with the subject at the time when the subject “applies” the nursing care requirement.

Next, a processing example using one information (personal information) among the non-event information will be described. In the personal information, it is assumed that a change of “a person who was healthy has a decrease in muscle strength and a decrease in activity” has occurred. Further, in the personal information, it is assumed that a change of “a person who was able to perform cleaning or tidying is unable to perform cleaning or tidying, is unable to take care of a garden, and has a decrease in motivation” has occurred. In this case, the timing generation unit 1124 notifies the analysis unit 1123 that an analysis timing has arrived. The analysis unit 1123 derives the housekeeping service from the information as the proposal information. As described above, when one or more biometric information are changed and one or more living information are also changed, the timing generation unit 1124 may notify that the analysis timing has arrived.

Next, a processing example using a combination of all the non-event information (personal information, building information, and money information) will be described. In the personal information, it is assumed that a change of “certification of support requirement 1” has occurred. It is assumed that “a floor plan (IF sanitary, LDK, Japanese-style room) to allow living on one floor”, is recorded as the building information, “wanting to continue living at home (do not want to go to facility)” is recorded as the personal information, and “pension income (with margin) and financial asset present” is recorded as the money information. In this case, the timing generation unit 1124 notifies the analysis unit 1123 that an analysis timing has arrived. The analysis unit 1123 derives the reformation and the activity maintenance inside and outside the home from the information as the proposal information. The proposal information indicates a proposal for continuing home nursing care without raising the nursing care degree at a step of receiving the certification of support requirement 1.

Next, an example in which the life information is acquired before at least any one of the first timing or the second timing arrives, and the acquired life information is updated will be described. For example, it is assumed that “turning 60 years old” is determined as the first timing, and it is determined that the second timing is to acquire an interview result with the advisor at this timing. In this case, when the biometric information is changed, such as a decrease in the walking speed, the life information obtained by the advisor is updated by advancing the second timing.

Next, an example of changing the first timing based on the change in the life information will be described.

For example, although “turning 60 years old” is determined as the first timing, the first timing is changed to “turning 65 years old” because of the good biometric information.

Next, a processing example using the event will be described. Before the description, the stress database 1200G will be described.

The stress database 1200G is a database indicating a stress degree felt by the subject due to the event. FIG. 46 is a diagram showing an example of a stress degree and an event recorded in a stress database 1200G. The stress degree is indicated in three steps (high, medium, and low) depending on a level thereof. The event indicates an event in which stress occurs. The expression “parent” indicates that the corresponding event is an event in which the target is the subject. The expression “child” indicates that the corresponding event is an event in which the target is a child of the subject. In FIG. 46, the stress degree is indicated in three steps, but may be indicated in different step or may be indicated by numerical values. In addition, the event is an example, and other events may be included.

Basically, the analysis unit 1123 derives the proposal information for maintaining the mental and social health in the future when an event in which there is some problem with the body of the subject or the relative has occurred. In addition, the analysis unit 1123 derives the proposal information in which the stress or the impact of a plurality of categories (family relationship, body health, mental health, social health (including communication and role), and money relationship) do not overlap in the future. Further, the analysis unit 1123 derives the proposal information in consideration of not only the subject but also the stress received by the family. Further, the analysis unit 1123 derives the proposal information such that the couple including the subject does not overlap (avoidance of mutual exhaustion such as elderly nursing care) and the parents and descendants including the subject does not overlap (avoidance of double care of child rearing/nursing care).

It is assumed that the death of the spouse (high stress degree) is added as the event. In this case, the timing generation unit 1124 notifies the analysis unit 1123 that an analysis timing has arrived.

The analysis unit 1123 derives the proposal information in which the event with a high or medium stress degree in the stress database 1200G does not occur. Specifically, the analysis unit 1123 derives the proposal information such that the “own illness/injury” does not overlap. When the subject is particularly a man, follow-up on the living aspect and follow-up on the mental aspect are required. Therefore, the analysis unit 1123 derives the proposal information for performing such follow-up. Since the event occurrence time is often not predictable for a case where the stress degree is high, the analysis unit 1123 derives a coping method or the proposal information (for example, intervention of the expert) before the event occurrence, during the event occurrence, and after the event occurrence.

It is assumed that a significant change (medium stress degree) in health or behavior of the family is added as the event. In this case, the timing generation unit 1124 notifies the analysis unit 1123 that an analysis timing has arrived. The analysis unit 1123 derives the proposal information in which the event with a high or medium stress degree in the stress database 1200G does not occur. For example, the analysis unit 1123 derives the proposal information for maintaining the physical, mental, and social health of the subject. When a significant change in health or behavior of the family occurs, it is common to prioritize immediate family care in the short term, but it is important to have one's own field (connection with people and free time) in the long term.

It is assumed that a significant change in one's own illness or injury (high stress degree) or health or behavior of family (spouse) (medium stress degree) is added as the event. In this case, the timing generation unit 1124 notifies the analysis unit 1123 that an analysis timing has arrived. The analysis unit 1123 derives the proposal information in which the event with a high or medium stress degree in the stress database 1200G does not occur. For example, when an illness/injury occurs in one of the couple, the analysis unit 1123 derives the proposal information for following the other.

The same applies to a case where an event occurs for the subject and the child of the subject. For example, when the subject has an illness or an injury (high stress degree) or a significant change in health or behavior of the family (medium stress degree), the timing generation unit 1124 notifies the analysis unit 1123 that the analysis timing has arrived. The analysis unit 1123 derives the proposal information in which the event with a high or medium stress degree in the stress database 1200G does not occur to the child.

On the contrary, when a significant change in the examination (medium stress degree) or the living environment (low stress degree) of the child is added to the child, the timing generation unit 1124 notifies the analysis unit 1123 that the analysis timing has arrived. The analysis unit 1123 derives the proposal information in which the event with a high or medium stress degree in the stress database 1200G does not occur to the child. In a case of an event in which the occurrence timing is certain or almost certain, such as the examination of the child, the timing generation unit 1124 may notify the analysis unit 1123 that the analysis timing has arrived one year before the examination.

As described above, in the processing in a case of the event in which the occurrence timing is certain or almost certain, the timing generation unit 1124 notifies the analysis unit 1123 of the derivation timing before the first timing or the second timing arrives. In this case, the analysis unit 1123 derives the proposal information about a plan to be executed by the subject until the first timing or the second timing, and the output unit 1126 outputs the proposal information derived by the analysis unit 1123.

For example, before the timing of the retirement arrives, the analysis unit 1123 may derive the proposal information about a money plan for 30 years after the retirement as the plan to be executed before the retirement, and the output unit 1126 may output the proposal information. Further, when the nursing care of the parent of the subject is scheduled, examples of the money plan include calculation of monthly income and expenditure after the retirement (considering changes depending on the age group), grasping of a guideline of annual family event expenses (travel, homecoming, and the like), and estimation of costs to be kept as a lump sum of money.

The proposal information for further considering inheritance may be derived. This is because, when the creation of the money plan is postponed, there is a possibility of overlapping with other events.

As described above, the information management system 1010 can output the proposal information in synchronization with the timing or output the proposal information before the timing arrives.

Next, a processing example using the non-event information and the event will be described. In the biometric information, it is assumed that a change of “a person who was healthy has a decrease in muscle strength, a decrease in activity, and becomes fatigued easily” has occurred. In addition, it is assumed that “grandchild rearing support” and “spouse health anxiety” have occurred as events. In this case, the timing generation unit 1124 notifies the analysis unit 1123 that an analysis timing has arrived. The analysis unit 1123 derives, from the information, proposal information about the housekeeping service or the non-nursing care insurance service, a monthly money plan review when these services are used, future medical expenses/nursing care expenses (housing renovation expenses) consideration, and proposal information about support for education expenses of child or grandchild.

For another example, it is assumed that a change of “concern about initial cognitive impairment and decrease in leg strength” has occurred in the biometric information. It is assumed that “use in combination with home rental” is recorded as the building information, and “single, busy child, decrease in frequency of going out (decrease in friends also affects), and no longer caring about grooming (what is worn suddenly becomes casual)” is recorded as the living information. Further, it is assumed that “completed repayment of the cost of building a tenement house (=resulting in financial leeway)” is recorded as the money information.

In this case, the timing generation unit 1124 notifies the analysis unit 1123 that an analysis timing has arrived. The analysis unit 1123 derives, from the information, proposal information about provision/introduction of information of an appropriate relocation destination such as a service-equipped housing for elderly people or a paid nursing home, proposal information about sorting/disposal of luggage, proposal information about introduction of a housekeeping service, and proposal information about follow-up until the subject gets used to moving in on behalf of the child of the subject, as long as the person himself/herself can make a decision. For example, by providing the information of the appropriate relocation destination such as a service-equipped housing for elderly people or a paid nursing home, the anxiety of living alone of the person and the child is eliminated, and the person himself/herself can feel safe with 24-hour presence of people and a cafeteria.

Hereinafter, a summary of the change example and the event example will be described.

### Change in Biometric Information

Nursing care requirement certification received
Decrease in activity
Concerns about initial cognitive impairment
Decrease in going out frequency
Decrease in walking speed
Decrease in number of steps
Loss of appetite
Undernutrition
Weight loss
Hospital visits and hospital admissions due to injury or illness

### Living Information

Difficult in housework and grandchild rearing
Change in timing or frequency of needing to use toilet more frequently
Tiding unproperly
Cleaning incompletely
Decrease in visitors

### Change in Building Information

Reformation
Relocation
Route value
Location
Surrounding facilities

### Change in Money

Inherited from parents or spouse
Retirement allowance acquisition
Pension acquisition
Unearned income
Change in hospitalization/medical expenses for parents or nursing care expenses
Support for children and grandchildren
Event costs occurred in parents and descendants
Costs of life insurance for person himself/herself or spouse occurred
Hospitalization/medical expenses or nursing care expenses for person himself/herself or spouse occurred
Reforming costs occurred
Costs of living in a senior citizen house or facility occurred

### Event Example

Death of spouse
Illness or injury of himself/herself
Significant change in family health or behavior
Significant change in social activities
Retirement
Nursing care for elderly parents
Marriage and childbirth of children
School entrance of grandchild

Another proposal example of the proposal information described above will be described. The following proposal example is a diagram showing an example of an indoor environment proposal example, a housing environment proposal example, a health-related proposal example, a nursing care-related proposal example, and a finance-related proposal example.

The indoor environment proposal example and the housing environment proposal example will be described. As the indoor environment proposal example, when the combination of the input information is the biometric information (thermal sensation (becoming dull, not good at air conditioning)) and the building information (living environment simulation (solar radiation, ventilation, heating/cooling)), the analysis unit 1123 derives, as proposal information, “To prevent heatstroke, operate the air conditioner a little earlier than the time zone when it gets too hot due to the solar radiation of the summer. In spring and autumn (the intermediate periods), indicate the time zone when the ventilation can be used and make a proposal to stay cool without using the air conditioner”. As described above, it is possible to provide information about air conditioning in the indoor space in which the customer resides as the proposal information.

As the housing environment proposal example, when the combination of the input information is the building information (entrance key is not-double locked) and the living information (forgetting to lock the door), the analysis unit 1123 derives “proposal of remote control double lock installation” as the proposal information. As described above, it is possible to provide information about equipment that assists the life of the customer in the residence space as the proposal information.

As the housing environment proposal example, when the combination of the input information is the biometric information (current illness history (knee pain) and hospital visit situation (orthopedics)) and the building information (stairs in the entrance porch), the analysis unit 1123 derives “propose of installation of a handrail in the entrance porch” as the proposal information. As described above, it is possible to provide information about equipment that assists the life of the customer in the residence space as the proposal information.

As the housing environment proposal example, when the combination of the input information is the building information (deterioration in heat insulation performance) and the living information (large changes in temperature and humidity in the bathroom), the analysis unit 1123 derives “proposal of heat insulation reformation” as the proposal information. As described above, it is possible to provide information about equipment that assists the life of the customer in the residence space as the proposal information.

As the housing environment proposal example, when the combination of the input information is the biometric information (walking speed (tendency to decrease)) and the building information (floor plan information (LDK on the first floor, private room on the second floor)), the analysis unit 1123 derives “proposal of reformation to allow living on the first floor only” as the proposal information. As described above, it is possible to provide information about equipment that assists the life of the customer in the residence space as the proposal information.

As the housing environment proposal example, when the combination of the input information is the biometric information (walking speed (tendency to decrease)) and the building information (floor plan information (LDK on the first floor, private room on the second floor)), the analysis unit 1123 derives “proposal of reformation to allow living on the first floor only” as the proposal information. As described above, it is possible to provide information about equipment that assists the life of the customer in the residence space as the proposal information.

As the housing environment proposal example, when the combination of the input information is the biometric information (walking speed (tendency to decrease) and cognitive function (tendency to decrease)) and the living information (complaint of anxiety about living only for elderly people), the analysis unit 1123 derives “proposal of relocation (service-equipped housing for elderly people/nursing care home) or use of nursing care insurance service” as the proposal information. As described above, it is possible to provide information about nursing care of the customer as the proposal information.

As the housing environment proposal example, when the combination of the input information is the biometric information (walking speed (tendency to decrease) and the cognitive function (tendency to decrease) and the building information (floor plan information (assets available), and the living information (land use/inheritance intentions, with separate family), the analysis unit 1123 derives “proposal of inheritance measures in anticipation of the future of the entire family” as the proposal information. As described above, it is possible to provide information about the inheritance of the customer as the proposal information. In addition, the analysis unit 1123 can also make a proposal by a combination of three information of the biometric information, the building information, and the living information.

As the housing environment proposal example, when the combination of the input information is the building information (owning land other than the home) and the living information (separate family information (with home purchase plan)), the analysis unit 1123 derives “housing proposal for children by an unused land” as the proposal information. As described above, it is possible to provide information about the assets of the customer as the proposal information.

As the housing environment proposal example, when the combination of the input information is the building information (with a garden) and the living information (no longer able to maintain the garden), the analysis unit 1123 derives “proposal of the garden tree pruning and weed removal services” as the proposal information. As described above, it is possible to provide information about a service that assists the life of the customer in the residence space as the proposal information.

As the housing environment proposal example, when the combination of the input information is the biometric information (back pain), the building information (the road in front of the home is sloped), and the living information (with a trouble in shoveling snow when it snows), the analysis unit 1123 derives “proposal of a snow shoveling service” as the proposal information.

As described above, it is possible to provide information about a service that assists the life of the customer in the residence space as the proposal information.

As the housing environment proposal example, when the combination of the input information is the biometric information (knee pain, walking speed (tendency to decrease)) and the living information (risk of falling due to a baggage on the floor in the hallway), the analysis unit 1123 derives “proposal of a tidying service” as the proposal information. As described above, it is possible to provide information about a service that assists the life of the customer in the residence space as the proposal information.

Next, the health-related proposal example, the nursing care-related proposal example, the finance-related proposal example, and the indoor environment proposal example will be described. As the health-related proposal example, when the combination of the input information is the biometric information (initial cognitive impairment), the living information (cohabiting family information (living alone) and separate family information (worry about parents, need for watching over)), the analysis unit 1123 derives “proposal of conversation partner/watching over” as the proposal information.

As described above, it is possible to provide information about a service that assists the life of the customer in the residence space as the proposal information.

As the health-related proposal example, when the combination of the input information is the biometric information (nutritional status (low food intake)) and the living information (reluctance to prepare meals), the analysis unit 1123 derives “proposal of a cooking service” as the proposal information. As described above, it is possible to provide information about a service that assists the life of the customer in the residence space as the proposal information.

As the health-related proposal example, when the combination of the input information is the biometric information (walking speed (tendency to decrease), the number of steps (tendency to decrease)), and the living information (staying at home more often), the analysis unit 1123 derives “proposal of indoor exercises” as the proposal information. As described above, it is possible to provide information about the improvement of the health of the customer as the proposal information.

As the nursing care-related proposal example, when the combination of the input information is the biometric information (the person has a bad physical condition due to illness and is unable to move around as he or she wants) and the living information (the person needs to apply for nursing care certification and cannot rely on a child living separately), the analysis unit 1123 derives “proposal of follow-up on nursing care requirement certification application” as the proposal information. As described above, it is possible to provide information about nursing care of the customer as the proposal information.

As the nursing care-related proposal example, when the combination of the input information is the biometric information (approaching 80 years old) and the living information (healthy now, but anxiety about the future, so that information about nursing care in an area where he or she lives is necessary), the analysis unit 1123 derives “proposal of local information provision” as the proposal information. As described above, it is possible to provide information about nursing care of the customer as the proposal information.

As the nursing care-related proposal example, when the combination of the input information is the biometric information (walking speed (tendency to decrease), sleeping situation (not sleeping well), and the living information (long-distance nursing care for superaged parents), the analysis unit 1123 derives “proposal of respite care” as the proposal information. As described above, it is possible to provide information about the improvement of the health of the customer as the proposal information.

As the nursing care-related proposal example, when the combination of the input information is the biometric information (nursing care requirement 2) and the living information (cohabiting family information (wanting to travel with friends but giving up), and the necessary nursing care insurance service is insufficient (short stay)), the analysis unit 1123 derives “proposal of a second opinion” as the proposal information. As described above, it is possible to provide information about nursing care of the customer as the proposal information.

As the finance-related proposal example, when the combination of the input information is the building information (building type (private house, tenement house)) and the living information (owned real estate (one private house and one tenement house owned, owned real estate (route value information), and financial asset (a plurality of banks/securities owned)), the analysis unit 1123 derives “proposal of inheritance plan or inheritance measure” as the proposal information. As described above, it is possible to provide information about the inheritance of the customer as the proposal information. It should be noted that “a plurality of banks/securities owned” in the financial information indicates that a plurality of bank deposits, postal savings, securities, and the like are owned.

As the finance-related proposal example, when the combination of the input information is the building information (building type (private house, tenement house)) and the living information (monthly income (pension, rental income), financial asset (a plurality of banks/securities owned)), the analysis unit 1123 derives “proposal of money plan in anticipation of the future (monthly flow and stock plan)” as the proposal information. As described above, it is possible to provide information about the asset as the proposal information.

As described above, the information management system 1010 can provide a technology for suitably outputting a proposal for maintaining or improving the QOL of the subject. In particular, even in the same building, the life information differs depending on the person who lives, and thus it is possible to output appropriate proposal information according to the building and the subject. In addition, all of the proposals are for maintaining the QOL of the customer or improving the quality of life of the customer.

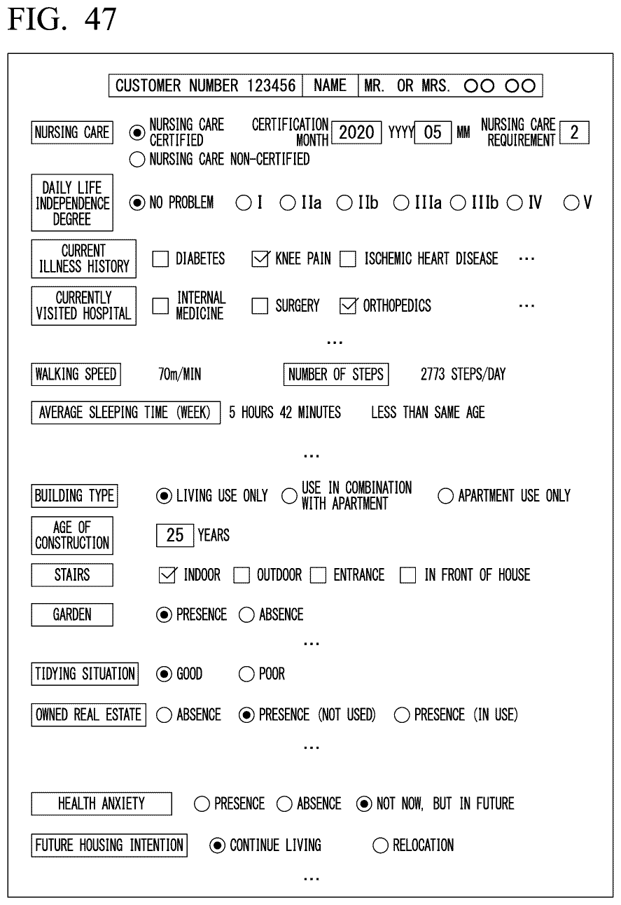

Next, an input screen for biometric information or the like will be described. FIG. 47 is a diagram showing an example of the input screen. The input screen is displayed on the display unit 1112. In the input screen, an input field is provided for each data item of the biometric information and the living information. The advisor selects the corresponding item using a radio button or a check box, or inputs the corresponding item in a text box. For example, when the nursing care is certified in “nursing care”, the advisor selects a radio button of “nursing care certified” and inputs a certification month or a nursing care requirement level in the text box. In addition, a daily life independence degree input field is provided as information about a fact recognition ability. In the daily life independence degree input field, a field for inputting the daily life independence degree and a field for inputting no problem when there is no problem are provided.

On the other hand, the information acquired by the sensor is automatically displayed. For example, a “walking speed” or “number of steps” acquired by the sensor is automatically displayed.

In the input screen shown in FIG. 47, the information input by the advisor is stored in the database 1200.

### APPENDIX

(1) An information management system including: an acquisition unit configured to acquire biometric information about a living body of a customer and living information about living of the customer; and an output unit configured to output the biometric information and the living information acquired by the acquisition unit in association with individual recognition information of the customer.
(2) The information management system according to (1), in which the biometric information is information about at least one of a fact recognition ability of the customer and an exercise function of the customer.
(3) The information management system according to (2), further including: an analysis unit configured to perform analysis based on a combination of the biometric information and the living information, which are acquired by the acquisition unit, and to derive proposal information for maintaining a quality of life of the customer or improving the quality of life of the customer, in which the output unit outputs the proposal information derived by the analysis unit.
(4) The information management system according to (3), in which the analysis unit derives the information for improving the quality of life of the customer as the proposal information based on the fact recognition ability of the customer and the exercise function of the customer.
(5) The information management system according to (4), in which the analysis unit derives an independence degree and a nursing care degree, which serve as the information for improving the quality of life of the customer, as the proposal information.
(6) The information management system according to any one of (3) to (5), further including: a comparison unit configured to output a comparison result obtained by comparing comparable data items among the biometric information and the living information, which are newly acquired by the acquisition unit, or the proposal information newly derived by the analysis unit.
(7) The information management system according to any one of (3) to (6), in which the proposal information includes information about air conditioning in an indoor space in which the customer resides, information about equipment or a service that assists the life of the customer in a residence space, information about improvement of health of the customer, information about inheritance of the customer, information about an asset of the customer, or information about nursing care of the customer.
(8) The information management system according to any one of (1) to (7), in which the living information includes residence space information about the residence space in which the customer resides or lifestyle information indicating thoughts on a lifestyle of the customer.
(9) A program causing a computer to function as the information management system according to any one of (1) to (8).
(10) An information management method including: an acquisition step of acquiring, by a computer, biometric information about a living body of a customer and living information about living of the customer; and an output step of outputting, by the computer, the biometric information and the living information acquired in the acquisition step in association with individual recognition information of the customer.

### APPENDIX 2

(1) An information management system including: an acquisition unit configured to acquire life information of a subject; and a generation unit configured to generate timing information about a timing of a change in life of the subject based on the life information acquired by the acquisition unit.
(2) The information management system according to (1), further including: an analysis unit configured to perform analysis based on the life information acquired by the acquisition unit and to derive proposal information for maintaining a quality of life of the subject or improving the quality of life of the subject; and an output unit configured to output the proposal information derived by the analysis unit.
(3) The information management system according to (2), in which the generation unit generates a timing at which the acquisition unit acquires the life information, a timing at which the analysis unit derives the proposal information, or a timing at which the output unit outputs the proposal information, based on the life information acquired by the acquisition unit.
(4) The information management system according to (2) or (3), in which the life information includes at least two of personal information about the subject, building information, and money information.
(5) The information management system according to (4), in which the life information includes the personal information and the building information.
(6) The information management system according to (4), in which the life information includes the personal information, the building information, and the money information.
(7) The information management system according to (2) or (3), in which the life information includes at least two of personal information, building information, and money information about the subject, and the analysis unit performs the analysis based on a combination of the at least two of the personal information, the building information, and the money information about the subject, and derives the proposal information.
(8) The information management system according to (7), in which the analysis unit performs the analysis based on a combination of the personal information and the building information and derives the proposal information.
(9) The information management system according to (7), in which the analysis unit performs the analysis based on a combination of the personal information, the building information, and the money information and derives the proposal information.
(10) The information management system according to (2), in which the generation unit generates a first timing determined by an age of the subject and a second timing determined according to a change in the life information.
(11) The information management system according to (10), in which the acquisition unit acquires the life information when any of the first timing or the second timing arrives, and updates the acquired life information.
(12) The information management system according to (10), in which the acquisition unit acquires the life information before at least one of the first timing or the second timing arrives, and updates the acquired life information.
(13) The information management system according to (10), in which the generation unit changes the first timing based on the change in the life information.
(14) The information management system according to (10), in which the analysis unit derives the proposal information in synchronization with the first timing, and the output unit outputs the proposal information derived by the analysis unit.
(15) The information management system according to (10), in which the analysis unit derives the proposal information in synchronization with the second timing, and the output unit outputs the proposal information derived by the analysis unit.
(16) The information management system according to (2), in which the proposal information includes at least two of information for improving health of the subject, information for improving living of the subject, and money information.
(17) The information management system according to (10), in which the analysis unit derives the proposal information about a plan to be executed by the subject until the first timing or the second timing, and the output unit outputs the proposal information derived by the analysis unit.
(18) The information management system according to (10), in which the generation unit generates a third timing determined by an age of a relative of the subject.
(19) The information management system according to any one of (4) to (9), in which the personal information is information heard from the subject or information output by a sensor that senses the personal information.
(20) A program causing a computer to function as the information management system according to any one of (1) to (19).
(21) An information management method including: an acquisition step of acquiring, by a computer, life information of a subject; and a generation step of generating, by the computer, timing information about a timing of a change in life of the subject based on the life information acquired in the acquisition step.

In the above-described embodiment, the customer is assumed to be an individual of a so-called senior generation or middle generation, but the biometric information and the living information are information that can be acquired from any generation. Therefore, the above-described embodiment may be applied to customers other than the senior generation and the middle generation.

As described above, although embodiments of the present invention are described in detail with reference to the drawings, the specific configuration is not limited to the embodiments, and design and the like are included in the scope of the gist of the present invention.

### REFERENCE SIGNS LIST

1 Matching system
10 Customer terminal device
20 Service provider terminal device
30 Matching server
110 Situation evaluation result acquisition unit
120 Customer-side priority determination unit
130 Customer-side service selection unit
210 Provision condition acquisition unit
220 Delivery date information acquisition unit
310 Customer-side information acquisition unit
320 Provider-side information acquisition unit
330 Extraction unit
340 Matching unit
350 Presentation unit 5 Information management system
50 Terminal
510 Communication unit
511 Input unit
512 Display unit
520 Control unit
521 Display control unit
522 Information acquisition unit
523 Analysis unit
524 Timing generation unit
525 Comparison unit
600 Database
600A Application acquisition database
600B Building database
600C Interview observation database
600D Proposal history database
600E Analysis database 1010 Information management system
1100 Terminal
1110 Communication unit
1111 Input unit
1112 Display unit
1120 Control unit
1121 Display control unit
1122 Information acquisition unit
1123 Analysis unit
1124 Timing generation unit
1200 Database
1200A Biometric information database
1200B Living information database
1200C Building information database
1200D Money information database
1200E Event database
1200F Timing database
1200G Stress database
1200H Analysis database

1. A matching system comprising:
a situation evaluation result acquisition unit configured to acquire a situation evaluation result including a service proposal content for a customer according to customer needs;
a customer-side priority determination unit configured to determine priority of the customer for the needs based on the situation evaluation result and a predetermined index criterion;
a customer-side service selection unit configured to select a candidate for a service to be matched from among a plurality of services based on the situation evaluation result and the determined priority of the customer;
a provision condition acquisition unit configured to acquire a provision condition of the service of a service provider;
a customer-side information acquisition unit configured to acquire the selected candidate for the service to be matched;
a provider-side information acquisition unit configured to acquire the provision condition;
an extraction unit configured to extract services of a proposal candidate based on the acquired candidate for the service to be matched and the provision condition on a provider side;
a matching unit configured to select a service to be proposed to the customer from among the extracted services of the proposal candidate; and
a presentation unit configured to present the service selected by the matching unit to the customer and the service provider.

2. The matching system according to claim 1,
wherein the customer-side priority determination unit determines whether or not the customer needs indicated by the situation evaluation result correspond to a life event that is an important event in a lifetime of the customer, based on a predetermined determination criterion.

3. The matching system according to claim 1, further comprising:
a delivery date information acquisition unit configured to acquire delivery date information of the service provided by the service provider,
wherein the provider-side information acquisition unit further acquires the delivery date information, and
the presentation unit presents the delivery date information of the extracted services of the proposal candidate to the customer.

4. The matching system according to claim 1, further comprising:
a delivery date information acquisition unit configured to acquire delivery date information of the service provided by the service provider,
wherein the provider-side information acquisition unit further acquires the delivery date information, and
the matching unit selects a service to be proposed to the customer by giving priority to a service with an earlier delivery date, based on the extracted services of the proposal candidate and the delivery date information of the services.

5. The matching system according to claim 1,
wherein the customer-side service selection unit selects a service with a relatively low added value when the priority of the customer is relatively low, and selects a service with a relatively high added value when the priority of the customer is relatively high, from among the plurality of services.

6. The matching system according to claim 5,
wherein the service with the relatively low added value includes a standard service provided by predetermined condition determination, and
the service with the relatively high added value includes a non-standard service provided by individual consideration based on a situation of the customer.

7. A customer terminal device comprising:
a situation evaluation result acquisition unit configured to acquire a situation evaluation result including a service proposal content for a customer according to customer needs;
a customer-side priority determination unit configured to determine priority of the customer for the needs based on the situation evaluation result and a predetermined index criterion;
a customer-side service selection unit configured to select a candidate for a service to be matched from among a plurality of services based on the situation evaluation result and the determined priority of the customer;
an acquisition unit configured to acquire, from a matching server, information of the service selected based on the candidate for the service to be matched, which is selected by the customer-side service selection unit, and a provision condition of the service on a provider side;
a presentation unit configured to present the acquired information of the service.

8. A computer readable medium including a program causing a computer to execute:
acquiring a situation evaluation result including a service proposal content for a customer according to customer needs;
determining priority of the customer for the needs based on the situation evaluation result and a predetermined index criterion;
selecting a candidate for a service to be matched from among a plurality of services based on the situation evaluation result and the determined priority of the customer;
acquiring a provision condition of the service of a service provider;
acquiring the selected candidate for the service to be matched;
acquiring the provision condition;
extract services of a proposal candidate based on the acquired candidate for the service to be matched and the provision condition on a provider side;
selecting a service to be proposed to the customer from among the extracted services of the proposal candidate; and
presenting the selected service to the customer and the service provider.
